(19) United States
(12) Patent Application Publication
(10) Pub. No.: US 2014/0280314 A1
(43) Pub. Date: Sep. 18, 2014

(54) Dimensional Articulation and Cognium Organization for Information Retrieval Systems

(71) Applicant: Advanced Search Laboratories, lnc., Allen, TX (US)

(72) Inventors: Jason Coleman, Cedar Point, TX (US); Larry Hebel, Plano, TX (US)

(73) Assignee: Advanced Search Laboratories, lnc., Allen, TX (US)

(21) Appl. No.: 14/209,627

(22) Filed: Mar. 13, 2014

Related U.S. Application Data
(60) Provisional application No. 61/781,725, filed on Mar. 14, 2013.
(60) Provisional application No. 61/781,683, filed on Mar. 14, 2013.
(60) Provisional application No. 61/781,551, filed on Mar. 14, 2013.
(60) Provisional application No. 61/781,770, filed on Mar. 14, 2013.
(60) Provisional application No. 61/781,518, filed on Mar. 14, 2013.
(60) Provisional application No. 61/781,711, filed on Mar. 14, 2013.
(60) Provisional application No. 61/781,590, filed on Mar. 14, 2013.
(60) Provisional application No. 61/781,610, filed on Mar. 14, 2013.
(60) Provisional application No. 61/781,386, filed on Mar. 14, 2013.
(60) Provisional application No. 61/781,572, filed on Mar. 14, 2013.

(51) Int. Cl. G06F 17/30

(52) U.S. Cl. CPC G06F 17/30424
USPC 707/769

(57) ABSTRACT

Systems and methods are provided that relate to dimensional articulation and cognium organization in information retrieval systems. These include, without limitation, the refinement, elucidation and presentation of dimensionally articulated controls; methods for utilizing cognium based dimensional data in the context of an information retrieval system; methods that enable hinting and inference processes for sememetic casting of terms within an IR system; methods that enable machine and human collaboration on the creation, editing, maintenance, and evaluation of dimensional tag curation for indexed artifacts; methods that enable an information retrieval system to dimensionally articulate the results of semantic analysis of an input query; methods that enable creating, editing and using training artifact sets for dimensional curation in an IR system; methods that enable creating and editing custom curation definitions; and methods for creating, maintaining and using role based indices in a dimensionally articulated IR system.

### CLAIM OF PRIORITY AND CROSS-REFERENCE TO RELATED APPLICATIONS

The present application is related to U.S. Provisional Patent Application No. 61/781,725 filed Mar. 14, 2013, entitled “Sememe Casting and Inference Methodologies for Information Retrieval Systems,” to U.S. Provisional Patent Application No. 61/781,683, filed Mar. 14, 2013, entitled “Machine-Human Curation for Information Retrieval Systems,” to U.S. Provisional Patent Application No. 61/781,551, filed Mar. 14, 2013, entitled “Dimensional Articulation of Semantically Processed Input Queries,” to U.S. Provisional Patent Application No. 61/781,770, filed Mar. 14, 2013, entitled “Training Artifact Sets for Dimensional Curation in Information Retrieval Systems,” to U.S. Provisional Patent Application No. 61/781,518, filed Mar. 14, 2013, entitled “Custom Curation for Information Retrieval Systems,” to U.S. Provisional Patent Application No. 61/781,711, filed Mar. 14, 2013, entitled “Role Based Indexes In A Dimensionally Articulated IR System,” to U.S. Provisional Patent Application No. 61/781,590, filed Mar. 14, 2013, entitled “Dimensional Metadata Apparatus and Process for Information Retrieval Systems,” to U.S. Provisional Patent Application No. 61/781,610, filed Mar. 14, 2013, entitled “Dimensional Stemming for Information Retrieval Systems,” to U.S. Provisional Patent Application No. 61/781,386, filed Mar. 14, 2013, entitled “Cogniums As Organizational Structures In Dimensional Systems,” and to U.S. Provisional Patent Application No. 61/781,572, filed Mar. 14, 2013, entitled “Dimensional Casting Inference Methodologies for Information Retrieval Systems.” The present application hereby claims priority under U.S.C. §119(e) to U.S. Provisional Patent Application No. 61/781,725, U.S. Provisional Patent Application No. 61/781,683, U.S. Provisional Patent Application No. 61/781,551, U.S. Provisional Patent Application No. 61/781,770, U.S. Provisional Patent Application No. 61/781,518, U.S. Provisional Patent Application No. 61/781,711, U.S. Provisional Patent Application No. 61/781,590, U.S. Provisional Patent Application No. 61/781,610, U.S. Provisional Patent Application No. 61/781,386, and to U.S. Provisional Patent Application No. 61/781,572.

### TECHNICAL FIELD

The invention is generally related to database storage, database search, natural language processing, artifact representation in a machine-readable medium, information retrieval systems, and the Internet.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### DISCUSSION

The invention relates to many Web-based and computer based applications, including, but not limited to search, social network applications and information retrieval processes that support these applications. Searching for information or specific artifacts that contain information or other resources on the basis of identifying characteristics, whether on the web or on some other electronic device (computer or smartphone for example), is, for most people, a daily activity. The extension and enhancement of human knowledge and net intelligence fostered by the development and growth of this kind of activity may be rivaled only by the invention of the printing press or of written communication itself. The core processes that make this kind of activity possible are best referred to by the term “Information Retrieval.” Similarly, a large number of people and organizations create, collect, tag and distribute private and public information via social networks. The utility of such systems as information networks operating as objective sources of truth regarding general information is debatable. However, when information residing in these systems is cast as term facet characteristics that transparently expose the source and subjectivity of source, such systems can become powerful resources for profoundly rich and complex apparatuses of extending human intelligence, collective or individual memory, social knowledge and accessible information. Further, individuals may similarly create, tag, collect and distribute information for personal or shared use in the same manner with similar results and applications.

### BRIEF DESCRIPTION OF THE DRAWINGS AND TABLES

Various aspects of the invention, as well as an embodiment, are better understood by reference to the following detailed description. To better understand the invention, the detailed description should be read in conjunction with the drawings and tables, in which the following is illustrated:

FIG. 101—Artifact & Metadata Association with Single Key Value Pair illustrates a representative embodiment of an artifact record;

FIG. 102—Artifact & Metadata Associations with Multiple Key Value Pairs illustrates a representative embodiment of an artifact record;

FIG. 103—Artifact & Metadata Association with Multiple Tuples illustrates a representative embodiment of an artifact record;

FIG. 104—Artifact & Use Case Metadata Association with Tuples illustrates a representative embodiment of an artifact record;

FIG. 105—Artifact & Metadata Association with Simple Associative Array illustrates a representative embodiment of an artifact record;

FIG. 106—Artifact & Metadata Association with Multi-Part Associative Array illustrates a representative embodiment of an artifact record;

FIG. 107—Artifact & Metadata Association with Complex Associative Arrays illustrates a representative embodiment of an artifact record;

FIG. 108—Cognits as Tuples illustrates a representative embodiment of a cognit data structure;

FIG. 109—Cognits as Associative Arrays illustrates a representative embodiment of a cognit data structure;

FIG. 110—Cognium Interaction Perspective of a Dimensional Search Query Construction Process illustrates a representative embodiment process for how cognits are associated with terms;

FIG. 111—Cognium Interaction Perspective of a Dimensional Search Query Response Process illustrates a representative embodiment process for how cognit collections are associated with artifact record collections;

FIG. 201 illustrates an embodiment of process steps taken creating a custom curation definition;

FIG. 202 illustrates an embodiment of process steps taken editing a custom curation definition;

FIG. 203 illustrates an embodiment of process steps when using a custom curation definition;

FIG. 301 illustrates an embodiment of a process of artifact curation of one embodiment of the present invention;

FIG. 302 illustrates an embodiment of process steps taken during machine artifact curation of one embodiment of the present invention;

FIG. 303 illustrates an embodiment of process steps taken during human artifact curation corrections of one embodiment of the present invention;

FIG. 304 illustrates an embodiment of process steps taken during human manual tagging curation of one embodiment of the present invention;

FIG. 305 illustrates an embodiment of process steps taken during human cognium curation of one embodiment of the present invention;

FIG. 601 illustrates a process of term and concept registration;

FIG. 602 illustrates a process of cognit maintenance;

FIG. 603 illustrates a process of cognit annotation;

FIG. 604 illustrates a process of cognit harmonization;

FIG. 700 illustrates an example of the utilization of natural language input for a dimensionally articulated IR system;

FIG. 800—Dimensional Hinting Inference Process illustrates an embodiment for a process to provide dimensional hinting feedback;

FIG. 801—Dimensional Inference Set Selection Process illustrates a process related to the generation of a set of dimensional hints;

FIG. 803—Variable Vocabulary Integration with Dimensional Term Inference Processes illustrates an integration of multiple vocabularies with dimensional hinting processes;

FIG. 804—Dimensional Pivoting Process illustrates a process for the generation of and interaction with pivot-focused dimensional hinting;

FIG. 805—Dimensional Pivoting Inference Process illustrates a process for the generation of pivot-focused dimensional hints;

FIG. 806—Display of Relevant Dimensions for Artifacts illustrates an apparatus for the presentation of pivot-focused hints from the context of a returned artifact;

FIG. 807 Display of Relevant Dimensions for Queries illustrates an apparatus for the presentation of pivot-focused hints from the context of a query;

FIG. 1001 illustrates an embodiment of process steps taken during definition of dimensional tag roots;

FIG. 1002 illustrates an embodiment of process steps taken during tagging with dimensional tag roots;

FIG. 1003 illustrates an embodiment of process steps taken during translation to dimensional tag roots;

FIG. 1101 illustrates an embodiment of process steps taken creating and maintaining a role based index;

FIG. 1102 illustrates an embodiment of process steps taken using a role based index;

FIG. 1401 illustrates an embodiment of process steps taken creating a training artifact set;

FIG. 1402 illustrates an embodiment of process steps taken editing a training artifact set;

FIG. 1403 illustrates an embodiment of process steps taken using a training artifact set;

FIG. 1700 illustrates an example of a process to provide sememetic hinting feedback and affordances for sememetic feedback interactions;

FIG. 1701 illustrates an example apparatus for the presentation of inferences and hints from the context of an IR system query; and

FIG. 1702 illustrates an example apparatus for the presentation of sememe information from the context of a returned artifact;

### SUMMARY

The present invention is generally related to information retrieval systems and associated technologies, processes, algorithms, methods and apparatuses. Many of these are commonly utilized in products regularly referred to as search engines, though that is an overly limiting category and should not be contemplated as a limiting factor for the scope of the inventive material herein disclosed.

More specifically, this includes:

Provision of systems, processes, apparatuses and methods for enabling scalable, flexible, customizable and interactive access to dynamically changing information that resides within distributed networks such as the Internet either in isolation or in aggregation with multiple such feeds and/or other sources of content such as databases or networks of databases or networks of heterogeneous data sources. These information sources can be organized, presented and interacted with in the system user interface (UI) of such a system as facets or other constructs for ontological or other categorical organization of information providing dimensionally articulated specificity of query expressions by being embedded and articulated via cognits organized in a cognium. Such categorical usage can be generalized or specifically customized to the user and context in which it is accessed.

Provision of user interface related systems, processes, apparatuses and methods for casting of search terms, including sememetic inference, sememetic hinting, and the enablement of sememetic casting via dimensional articulation. The invention utilizes data input into a dimensionally generic, stateless, or semi-generic input object to infer a sememetic intent of the user for a given term. It then communicates that inference back to the user, providing them with an opportunity to alter or correct the value of the inference and provide affordances to alter the assigned sememe.

Provision of systems, processes, apparatuses and methods for using collaborative automated machine processes and human directed machine tools to apply dimensional tags to indexed artifacts. This collaborative process is referred to as dimension tags curation. The invention also relates to using information collected from automated and manual curation activities to form a continuously improved accuracy for the curation results. Specifically that all indexed artifact curation correctly reflects the various identified dimensions appropriate to the artifact as demonstrated by its inclusion in results when performing machine queries in search of dimensionally related artifacts.

Provision of systems, processes, apparatuses and methods for creating, editing and using a collection (or set) of artifacts to define patterns for dimensional tagging. Through machine learning processes, target artifacts can be analyzed using the patterns derived from the training artifact collections; and upon successfully matching, in part or in whole, the expected patterns, determine if the target artifact can reasonably and accurately be associated with a given dimensional tag associated with a training artifact set.

Provision of systems, processes, apparatuses and methods for creating, editing and using a collection of search queries, dimensional tags and/or specific artifacts to form a custom curation definition. Custom curation definitions are saved in a cognium and referenced during searches within an IR system. The reference may be passive as a reference in a search query or active within the query when the content of the definition is included, in part or in total, in the body of the query. Either type of use also provides for dynamic edits in the form of overrides, i.e. replacements, insertions and deletions, of the custom curation definition. These may or may not be saved back into the cognium as a new custom curation definition or replacement for an existing custom curation definition.

Provision of systems, processes, apparatuses and methods for creating, maintaining and using an index or set of indices, each with a specific purpose, task or set of purposes and tasks which define its role, as dictated by an IR system in which dimensional tag content and artifact content is maintained to satisfy the information need of searches and queries for dimensional attributes and their related artifacts. Within a dimensionally articulated IR system, it is necessary to search dimensional tags and their content prior to searching artifact content to satisfy the needs of any user (human, machine or hybrid) of the IR system to provide specificity to artifact content queries.

Provision of systems, processes, apparatuses and methods for using and defining a cognium as a structure for dimensional axis labels on which artifacts are projected. The projection of an artifact onto a dimension axis is referred to as artifact curation and is accomplished by associating one or more dimension tags to an artifact. The invention relates to the registration, maintenance, annotation and harmonization of various terms and concepts from possibly unrelated sources, such as ontologies, taxonomies, vocabularies and dictionaries, into a cognium before and during their use as dimension tags and labels. The invention also relates to the creation of hierarchical, networked, categorical and referential relationships within the cognium during the aforementioned processes.

Provision of systems, processes, apparatuses and methods for UI related characteristics enabling and supporting dimensional casting of search terms, including dimensional inference, dimensional hinting, dimensional inference related to various vocabularies, dimensional pivot hinting and inference for dimensional pivot hinting. The invention utilizes the data input into a dimensionally generic, stateless, or semi-generic input object to infer the dimensional intent of the user for a given term. It then communicates that inference back to the user, providing them with an opportunity to alter or correct the value of the inference and provide affordances to alter the assigned dimensional intent.

In one example, there is a set of methods; some incorporate processes for matching cognits with input terms; others processes for matching artifact records with a query.

In one example, there is a system incorporates a set of modules comprising one or more processors programmed to execute software code retrieved from a computer readable storage medium containing software processes. The system may be embodied as a set of: cognium data schemas, cognit data storage modules, term-cognit matching modules, cognit-term-artifact matching modules, other retrieval modules, interaction modules and presentation modules.

In one example, there is alternatively a system or apparatus incorporating a particular data storage organization on a computer readable storage medium, coupled with a set of modules or objects comprising one or more processors programmed to execute software code retrieved from a computer readable storage medium, that is functionally targeted to support the needs of a dimensional IR system. Such software processes are exposed to the user via a human-machine interface, commonly called a UI (user interface), and may be, but is not limited to, a display device for interaction with a user via a pointing device, mouse, touchscreen, keyboard, a detected physical hand and/or arm or eye gesture, or other input device. This apparatus is embodied as a set of display object contained within a presentation space. These objects provide presentations of the state of one or more queries as modeled within the apparatus and expose opportunities for interaction from the user with the query in order to provide dimensionally articulated queries for submission to the IR system.

In one example, there is alternatively a system or apparatus incorporating a particular data storage organization on a computer readable storage medium, coupled with a set of modules or objects comprising one or more processors programmed to execute software code retrieved from a computer readable storage medium, that is functionally targeted to support the needs of a dimensional IR system. Such software processes are exposed to other software via an API (application programming interface) via messaging protocols. These messages provide presentations of the state of one or more queries as modeled within the apparatus and expose opportunities for interaction from the user/software with the query in order to provide dimensionally articulated queries for submission to the IR system.

In one example there are a set of methods comprising: a process for providing sememetic hinting to enable the capture of a user's intended meaning of a term; a process for enabling a user's meaningful interaction with a term's sememetic attributes; a process for providing these processes within the context of multiple vocabularies; a process for suggesting and enabling sememetic pivoting within a search query.

In one example there is a system including a set of modules comprising one or more processors programmed to execute software code retrieved from a computer readable storage medium containing software processes. This system includes: modules for enabling sememetic hinting to enable the capture of a user's intended meaning of a term; modules for enabling a user's meaningful interaction with a term's sememetic attributes; modules for providing these processes within the context of multiple vocabularies; modules for suggesting and enabling sememetic pivoting within a search query.

In one example, there is alternatively a system or apparatus including a set of modules comprising one or more processors programmed to execute software code retrieved from a computer readable storage medium containing software processes. This system includes a set of hidden processes and UI modules and presentation objects contained within a presentation space: modules for providing sememetic hinting to enable the capture of a user's intended meaning of a term; modules for enabling a user's meaningful interaction with a term's sememetic attributes; modules for providing these processes within the context of multiple vocabularies; modules for suggesting and enabling sememetic pivoting within a search query.

In one example, the invention is a set of methods, systems and apparatuses that include processes for capturing, analyzing and reporting curation activities on artifacts. These processes allow the invention to derive measures of the curation accuracy. These measures can then be used to alert machine and human curators, when and where necessary, to take specific corrective curation actions on a single or set of artifacts. Corrective actions may include, but are not limited to, adding more dimensional tags, changing dimensional tags previously applied and expanding the set of available dimensional tags. The processes provided to take corrective actions are monitored by human curators and, as needed, altered, customized and configured to conform to the content of the artifact.

In one example, the invention is a system or apparatus that enables humans and machines to work collaboratively to continuously improve curation accuracy through integrated curation tools implemented as machine automated and human controlled processes. All the processes provide an historical transaction audit to feed trace reports, human curator reviews and machine learning algorithms. The collaborative nature of the curation tool integration allows each action to benefit from awareness and information of prior, current and parallel activities. This integrated awareness is used to prevent infinite redundant processing, schedule and order dependent activities, and ensure all data integrity.

One example is a method that enables an IR system to dimensionally articulate the results of semantic analysis of an input query by analyzing a natural language query input so that is usable in a dimensionally articulated IR system.

One example is a system or apparatus that includes a set of modules or objects comprising one or more processors programmed to execute software code retrieved from a computer readable storage medium containing software processes. This system is embodied as a set of process, UI modules and presentation objects contained within a presentation space, including: modules for enabling the abstraction of the intended signs of a given body of a natural language query input so that they may be analyzed for association to cognits within a cognium; modules for the presentation of the resulting dimensional articulation of natural language query to the user.

In one example, the invention is a set of methods that includes processes for creating, editing and using a collection of artifacts to define a training set which defines the patterns used for analyzing target artifacts during curation in an IR system. A training artifact set is defined by human, machine or hybrid processes selecting a well-defined set of artifacts. A set is written to a data store for future user and maintenance. All of the training artifacts in a single set are then analyzed to define the patterns of content which defines (or is associated with) a single dimensional tag within the IR system. One or more artifacts may exist simultaneously within different training sets. The selection of the training artifacts will have a direct effect on the accuracy of the curation processes that analyze target artifacts to determine the reasonable application and association of a specific dimensional tag to a target artifact. During artifact curation, when training artifacts are applied via various machine learning processes, the curation process reports on the analysis processes using the results of the training sets to provide a feedback loop on the efficacy of the training artifact sets. This feedback may then cause a training artifact set to be edited via the addition or removal of artifacts. Sets may also be broken into subsets or merged into super sets to refine the patterns for new or existing dimensional tags.

In one example, the invention is a system or apparatus that enables humans and/or machines to create, edit and use training artifact sets. A set is defined at a minimum as a list of artifacts and a dimensional tag. A set is used to define the nature of the relationships and patterns observed in the collection of artifacts. An existing training artifact set is retrieved from a data store and analyzed by machine learning processes to produce a record of the patterns appearing in the set. These patterns may include but are not limited to the set of common terms, the order in which terms are used and the general common organization and structure within and between the artifacts. Specific details are dictated by the machine learning processes employed within the IR system. This pattern definition is most often written to a data store to optimize curation activities using the training artifact set during subsequent processing. Statistics are kept from the application of each training artifact set which are then used later to refine the set. For example, refinements may include adding or deleting artifacts from a particular set.

In one example, the invention is a set of methods that include processes for using, creating and editing custom curation definitions. Each custom curation definition has a unique identifier (label) and enumerates a set of artifacts to which to limit search results within an IR system. The custom curation definition is read from a cognium and may be used as defined or with dynamic changes as specified by the user. In this case the user of a custom curation definition may be a machine process, a human user or a collaboration of both. The custom curation definition limits the artifact set by any combination of (1) a reference to one or more custom curation definitions, (2) custom dimensional tags, (3) IR system provided dimensional tags and (4) enumeration (as an inclusion or an exclusion) of one or more specific artifacts. The custom curation definition may be created in a number of ways, including but not limited to, (1) user entry into a blank form, (2) performing a search and saving the query, (3) performing a search and selecting specific artifacts from the results or (4) editing an existing custom curation definition and saving the result under a different identifier (label). The custom curation definition may be edited dynamically by reference within a query which contains clauses that supersede the definition.

In one example, the invention is a system or apparatus that enables humans and/or machines to use, create and edit custom curation definitions including a set of modules or objects comprising one or more processors programmed to execute software code retrieved from a computer readable storage medium containing software processes. The custom curation definitions may be kept private to the creator (machine or human) or may be shared with others as desired by the creator. Any changes in the IR system which may affect existing custom curation definitions will automatically be applied to ensure the custom curation definition integrity and compatibility with the IR system. Use of custom dimensional tags may or may not be supported. When custom dimensional tags are available, they may or may not be limited by the IR and may or may not have any correspondence to or relationship with other existing custom dimensional tags and/or IR system provided dimensional tags.

In one example, the invention is a set of methods including processes for creating, maintaining and using role based indices in a dimensionally articulated IR system. Each index is associated with a defined purpose specific to autonomous tasks, called the index role. One or more indices are created to host and serve search results for dimensional tags content and/or artifact content. When a search process in the IR system needs to provide or validate dimensional information, the index assigned to the specific role is used for retrieval. A controller manages all indexes by role and serves to distribute requests. This also provides a number of benefits, such as server clustering and load balancing. The controller also forwards all maintenance activity to the managed indices.

In one example, the invention is a system or apparatus that enables humans and/or machines to create, maintain and use a collection of indices. Each index may incorporate one or more other indices which may replicate the same role, i.e. the behavior and features of each index is identical, and/or provide distinctive separate sub-roles which act collaboratively to satisfy any request received from a controller.

One example relates to systems, apparatuses and methods for using manual and automated processes to define, evaluate and retrieve roots for dimensional tags. During artifact curation, the process which associates dimensional tags to artifacts, information gleaned from the artifact is reduced to a consistent set of dimensional tags prior to association with the artifact. Later when a manual or automated process provides dimensional tag information for the purpose of finding an artifact in the IR system, the supplied dimensional tag must be reduced to the same consistent set to ensure successful retrieval of the desired artifacts.

One example includes apparatuses, systems and methods for defining, evaluating and retrieving roots for dimensional tags. A dimensional tag, at a minimum, must consist of a dimension name and a dimension value. The dimensions names and dimension values are recorded and maintained in a cognium. These can be managed manually and/or via automated processes. To ensure consistency across artifact curation and queries for artifacts in an IR system, all processes using and/or referencing the dimension tags are passed through a dimensional stemming process to determine the dimensional tag roots. This process is done while associating an artifact with the dimensional tag root, substituting the root in a query to ensure the IR system uses the correct dimensional tags for artifact retrieval and for any other process assigning and/or referencing indexed artifacts.

One example is a system or apparatus that enables humans and/or machines to define, evaluate and retrieve roots for dimensional tags. Automated processes may define new dimensional tags as needed and register them in a cognium for later use or successfully find existing dimensional tags in the cognium. Human machine interaction related processes allow for the refinement, correction, creation and removal of dimensional tags from the cognium.

In one example, there is a set of methods including processes for registering, maintaining, annotating and harmonizing terms and concepts from possibly unrelated sources into a cognium. Each term and concept provided by a source, such as manual human specification, controlled ontologies, published dictionaries and specialty vocabularies, is registered in the cognium as a cognit. The cognit allows the recording of additional information, such as a publisher, definition, signifier and context. After registration the cognit may be annotated with various attributes and harmonized against other cognits. Where appropriate, cognits can be associated in a way to represent any type of relationship, such as sibling, parent, child, synonym, antonym, etc. During harmonization, cognit relationships are validated to ensure self-contradictions and infinite recursive definitions do not exist, such as cognit A is defined as the parent of cognit B and cognit B is also defined as the parent of cognit A. Maintenance of the cognium is done both manually via human action and by automated processes as indicated by the cognit which defines the publisher for related cognits.

In one example, there is a system, method or apparatus that enables the creation and maintenance of cognit within a cognium by human and machine processes. The cognit may be annotated, manipulated and associated as necessary to provide the concepts and dimensional tags for curating artifacts. The cognium is accessed by various dimensional tagging methods and processes to provide the data necessary for artifact analysis during dimensional tagging.

In one example, there is a system, method or apparatus that enables the creation, maintenance and coordination for multiple cogniums to collaborate across a WAN, LAN or other interconnected system of data stores and processes.

One example is a set of methods comprising: a process for enabling dimensional hinting to enable the capture of a user's intended dimensional use of a term; a process for enabling a user's meaningful interaction with a term's dimensional attributes; a process for providing these processes within the context of multiple vocabularies; a process for suggesting and enabling dimensional pivoting within a search query.

One example is a system including a set of modules comprising one or more processors programmed to execute software code retrieved from a computer readable storage medium containing software processes. This system is embodied as a set of process and UI modules including: modules for enabling dimensional hinting to enable the capture of a user's intended dimensional use of a term; modules for enabling a user's meaningful interaction with a term's dimensional attributes; modules for providing these processes within the context of multiple vocabularies; modules for suggesting and enabling dimensional pivoting within a search query.

One example is alternatively a system or apparatus including a set of modules comprising one or more processors programmed to execute software code retrieved from a computer readable storage medium containing software processes. This system is embodied as a set of hidden processes and UI modules and display objects contained within a presentation space: modules for providing dimensional hinting to enable the capture of a user's intended dimensional use of a term; modules for enabling a user's meaningful interaction with a term's dimensional attributes; modules for providing these processes within the context of multiple vocabularies; modules for suggesting and enabling dimensional pivoting within a search query.

### DETAILED DESCRIPTION

### Overview

“Information Retrieval” or “IR” is a field whose purpose is the assembly of evidence about information and the provision of tools to access, understand, interact with or use that evidence. It is concerned with the capture or collection, structure, analysis, organization and storage of information. It can be used to locate artifacts in order to access the information contained therein or to discover abstract or ad-hoc information independent of artifacts.

“IR System” is one or more software modules, stored on a computer readable medium, along with data assets stored on a computer readable medium that, in concert perform the tasks necessary to perform information retrieval.

“Information” denotes any sequence of symbols that can be interpreted as a message.

“Information Extraction” or “IE” is a field concerned with the automated extraction of structured information from sets of one or more artifacts that may include unstructured, heterogeneously structured, or various forms of intermediately structured to unstructured information in some machine readable form.

“Data Mining” is a field concerned with the discovery of information or artifacts containing information for the purposes of information extraction. In the context of this document, this term should be understood to be extended to include common erroneous definitions of the term that contemplate more than the identification of information in whatever machine readable form it occurs but to also include the capture or collection, extraction, warehousing and analysis of that information.

“Artifact” denotes any discrete container of information. Examples include a text document or file (e.g. a TXT file, ASCII file, or HTML file), a rich media document or file (e.g. audio, video or image such as a PNG file), a text-rich media hybrid (e.g. Adobe PDF, Microsoft Word document, or styled HTML page), a presentation of one or more database records (e.g. a SQL query response, or such a response in a Web or other presentation such as a PHP page), a specific database record or column, or any such machine-accessible object that contains information. The above list includes artifacts that are accessible by information technology. By extrapolation artifacts can include reference to or meta-information about, regarding or describing physical objects, people, places, concepts, ideas or memes. Additional examples, in various embodiments could also include references to domains or subdomains, defined collections of other artifacts, or references to real world objects or places. While information technology systems provide reference to or presentations of these references, descriptions of the use process often conflates the reference artifact and the actual artifact. Such conflations should be interpreted referentially; in context to a process or apparatus as a reference; in context to a human being as the actual artifact, except whereas denoted as a representation of a term characteristic, facet presentation or other UI abstraction.

“Ad Hoc Information” denotes types of information that is represented, or can be demonstrated to be true, independently of a specific single source artifact. This comprises information about information (e.g. the query entered returned n number of results) that is a result for a query for information and may not reside in any discrete artifact prior to interaction with an IR system. (Though, of course such information could have been created by identical prior queries and cached in an artifact.) This can also describe information that is derived from other information, or from a large set of distinct artifacts and can be said to be generally true based on that evidence; an observable fact that can be derived from observing one or more artifacts that may or may not be explicitly contained within the target artifact(s).

“Abstract Information” denotes information that is represented, or can be demonstrated to be true, independently of a specific single source artifact. This includes mathematical assertions (e.g. 5=10/2) or any statement that can be asserted as corresponding to reality, independent of a source artifact. In an IR context such information is almost exclusively a construct of user perception and intent. In operation of a given IR apparatus queries for such information almost exclusively rely on a source artifact. While this may seem to be a pointless semantic distinction, it is important for interpreting many expressions regarding user intent.

“Structure” denotes that IR must include processes that address information that exists in a variety of forms; structured, unstructured or heterogeneous (e.g. a database record with fields or a text document with text content or a multimedia document with both).

“Analysis” denotes that IR must necessarily include processes that analyze the component characteristics of information; these include, but are not limited to context (including but not limited to location, internal citations and external citations), meta-characteristics (including but not limited to publish date, author, source, format, and version), terminology (including but not limited to term inclusion, term counts, and term vectors), format (physical and/or objective), empirical classification or knowledge discovery (i.e. machine learning: artificial intelligence analysis that leads to categorizing a given artifact as belonging to one or more classes, typically part of a systematic ontology, processes usually represented by one or more of Clustering, SVM, Bayesian Inference, or similar).

“Organization” denotes that IR must address the manner in which information is organized, both in the source artifact and in the storage of a resulting index; this is necessary to address the physical necessities of observing the contents of artifacts, the physical necessities of storing information about those artifacts as well as the underlying philosophies that guide both.

“Storage” denotes that all artifacts that contain information and all indexes that contain information about artifacts must be physically stored in a medium. That medium will have rules, capabilities and limitations that must be part of the consideration of all IR processes. This includes, but is not limited to databases (for example, SQL), hypertext documents (for example, HTML), text files (for example, PDF; .DOCX), rich media (for example, .PNG; .MP4). Storage also denotes that the IR process itself must store information about the artifacts it addresses (for example, an index or cache).

“Evidence” denotes information about information that is used as an input or feedback within the IR system. Evidence may be used transparently, represented to the user within the UI, or invisibly, hidden from perception by the user.

A query can be said to be comprised of components defining the evidence requirements for a desired result. Evidence is also a collection of characteristics that describe a result. Results that have the highest correspondence to a query's information need are the most relevant. The most relevant results are, ideally, the most useful in meeting the user's intent in searching for information, but this is not always the case. Usually this is because of an imperfect correlation with the expression of a query with a user's actual intent. For most IR systems, even the best formed query is at best an imperfect simplification of the actual user intent. This can occur for a number of reasons, including lack of understanding the manner in which the IR system operates, semantic error, too much ambiguity, too little ambiguity, and others. If all other aspects are equal, IR systems that achieve a higher degree of correlation between user intent and query input will produce better results, greater user satisfaction and competitive advantage. “Evidence” may, in many contexts, be synonymous with the terms “signals”, “data” or even “information.” Correlation between the evidence described in a query and evidence recorded in relation to a given artifact are the primary determinant of relevance (or ‘base relevance’). In many contexts and embodiments, “evidence” can also include a representation of the artifact that is the subject of the total evidence set. This representation may be a literal copy, stored in a given location, or may be tokenized, compressed, or otherwise altered for storage and/or efficiency purposes.

“Tools” denotes the interactive apparatus of the system, primarily the user interface (UI), but also includes the underlying components, processes and interconnected systems that enable the user to interact with the IR system and the concepts and ideas that drive it as well as the component facets, categories or other characteristics that impart structure and organization to the manner in which evidence, results and artifacts are accepted, assembled and presented by the IR system.

The ultimate purpose of IR is usability by and accessibility for human beings, even if that usability is several steps removed from presentation to a human user. Evidence generated (retrieved, observed, collected, predicted, tagged or classed) by IR systems is composed of fallible interpretations of the source artifact and fallible organization of evidence in the form of ontologies or other categorical structures. It would be a false assertion to claim that any representation of a source artifact stored by an IR process is not in some manner distorted, even if that distortion is one of context alone. These distortions are a necessary part of an IR process—many of the resulting qualities of distortion are positive (e.g. processing efficiency), but others may not be desirable (e.g. distortion of relevancy). An IR system that fails to address usability by and accessibility for human beings will only partially meet its potential value as a tool. If the utility of an IR system is not consumable by a human being it is irrelevant. By extension, the more consumable utility provided, the more valuable the system. Every IR system, through its structure, organization and user experience imparts and projects a particular world view and philosophy about the nature of information it addresses. This is a necessary part of an IR process, as information without organization and context is merely unusable data. Maintaining transparency to and even configurability of this world view increases the flexibility, usability, scalability and value of an IR system.

### Information Need

Information Need is the underlying impetus that drives a user to interact with an IR system. The primary interaction with an IR system is the query. Queries are most often some form of structured or unstructured string (text) input. Even in cases where queries are driven by complex rich media constructs (such as speech to text, chromatic or other processes) terms are almost always reduced or translated into string inputs. A truism of search engine user interaction is that queries are usually a poor representation of what the user wants, and of the information need that drives it.

A number of techniques and processes have been developed to assist users to assemble, refine or correct queries so that they better express what the user wants. These include: query suggestion; query expansion; term disambiguation hinting; term meaning expansion; polysemic disambiguation; homonymic disambiguation; and relevance feedback.

It is a common misconception among users that IR systems (search engines) are objectively truthful. The user typically believes the search engine is a means by which they can find accurate information. But there is an increasing trend to view search engines with greater suspicion; a growing awareness that search engines distort results. Examples of such distortions occur in the IR marketplace that are both intentional and unintentional. In this environment, providing transparency to the process and organization of search are generally desirable in IR systems.

### Information Conveyance

Retrieval of information by the IR system (capture) is a distinctly different process from retrieval of information by the user (access). While these processes are closely related in the context of IR, they rely on two completely unrelated primary operators—a computer (or similar machine, or collection of similar machines) and a human being, respectively. IR is ultimately about facilitating access to information by the human being. One way to express this is that an IR system is an apparatus that conveys information from a collection of sources to a human being. There are at least four types of information conveyance that can occur in the usage of an IR system. These are:
1. Directed access to an artifact
2. Education about an artifact
3. Education about the perceived meaning of evidence input (terms, etc.)
4. Information or inference about the organization of evidence in the IR system

“Directed access to an artifact” means providing a hyperlink, directions, physical address or other means of access to or representation of an artifact.

“Education about an artifact” means, through the user interface of the IR system, providing the user with information about an artifact that appears in search results (e.g. where the artifact is located, the title of the artifact, the author of the artifact, the date the artifact was created, the context of the artifact, an abstract or description of the artifact or other similar information). This can also denote information about how the artifact is interpreted by the IR system, including but not limited to evidence and specific characteristics of evidence regarding the artifact (e.g. the most relevant terms or tags for the document outside the context of the current query, or those within the context of the query). This may include various forms of ad-hoc or abstract information.

“Education about the perceived meaning of evidence input” means, through the user interface of the IR system, providing the user with information about terms or concepts that were either entered by the user, or may be relevant to the terms entered by the user. This may include a list of related terms, an encyclopedia-like text description of the meaning of the a given concept associated with the input, images or other multimedia content, or a list of possible interpretations of terms aimed at achieving disambiguation for polysemic terms. This may include various forms of ad-hoc or abstract information.

“Information or inference about the organization of evidence in the IR system” means providing the user with information or inferences about how information may best be located using the IR system, with the tools that it provides or enables. A simple and common example of this kind of education occurs when, on most major search engines if a user enters the term “fortune 500 logos” a result similar to “-images for fortune 500 logos” which is a link to a vertical categorical search for the same terms. This prompts the user to interact with the system in a different manner and implies a more efficient use of the system in the future. Enabling these kinds of inferences on the part of the user enables them to make more insightful and efficient searches in the future. IR systems that actively promote these inferences and the work to expose the user to the characteristics of the IR systems world view, organization and philosophy can achieve higher quality interactions and results than those that do not. This may include various forms of ad-hoc or abstract information.

Ideally, the UI of an IR system presents the information of each of these forms of conveyance in a manner that informs, educates and motivates the user about the system to enable increased performance in current and future use. A system that achieves aspects of this ideal should obtain competitive advantage against systems that do not.

### Specificity

In most extant IR systems, quality is typically measured solely on the response of the IR system to queries. However, superior user experiences and qualitative outcomes are achievable in systems that also apply measures of quality to input; input being the totality of terms and term qualifiers entered by the user and/or inferred by the system. For purposes of this disclosure the term “Specificity” is used to describe the general quality of inputs by the user, which may or may not include refinements, inferences and disambiguations provided by the IR system. Input terms or queries with greater specificity can be said to be of higher quality than those of lower specificity. It is thus desirable for IR systems to produce, foster, inculcate, encourage or produce through user interaction, user experience methodologies or inference methodologies queries of greater specificity.

However, like relevance, specificity is best measured directly against the information need of the user. Such measures cannot always be directly and objectively derived by observation, though they can be inferred. In this sense it can be said that the greater the correlation between the user's information need and the systems interpretation of query and terms the higher the specificity of the query or terms.

The terms “term” and/or “input terms” are typically defined in relation to IR systems as the information (usually but not always written—also including but not limited to spoken, recorded or artificially generated speech, braille terminals, refreshable braille displays or other sensory input and output devices capable of supporting the communication of information) that is provided to the system by the user that comprises the query. For the purposes of this disclosure these terms should be understood to be expanded beyond their customary meaning to also include a variety of additional meta data that accompanies and complements the user input information. This additional information provides additional specificity to the query in that it can include (though is not limited to) dimensional data, facet casting data, disambiguation data, contextual data, contextual inference data and other inference data. This additional information may have been directly or manually entered by the user, may have been invisible to the user, or may have been implicitly or tacitly acknowledged by the user. Data about how the user has interacted with the terms to arrive at the complete set of meta data can also be included in some embodiments.

For the purposes of this disclosure the term “dimension,” “search dimension” or “facet” in relation to a term or artifact evidence connotes a categorical isolation of the term or artifact in its use and interpretation by the IR system to a particular category or ontological class or subclass. Dimensionality can be applied to any number of kinds of categorical schemas, both fixed or dynamic and permanent or ad-hoc. Both fixed ontologies (taxonomies) or variable ontologies can be applied as dimensions and can be implemented at various levels of class-subclass depth and complexity. In some embodiments and processes dimensionality may refer to an exclusive categorization of an artifact, term or characteristic. In other embodiments categorizations are not exclusive and may be weighted, include a number of dimensional references and/or include a number of dimensional references with variable relative weights. For example, in one embodiment, a simple ontology may divide all artifacts into two classes: “fiction” and “non-fiction.” In this embodiment if an artifact belongs to the “fiction” class it cannot belong to the “non-fiction” class. In another embodiment all artifacts may sort all artifacts into two classes “true” and “untrue” with each artifact being assigned a relative weight on a specific generalized scale (e.g. to 100, with 100 being the highest and 0 being the lowest rating) for each class, so that a given artifact might have a 20 “true” weight and an 80 “untrue” weight. Generalized scales may be zero sum, or non-zero sum for these purposes. In still other embodiments, multiple ontologies or schemas could be combined. For example the “fiction/non-fiction” and “true/untrue” ontologies could be combined into a single IR system that exposes and enables searching for all four dimensions.

For the purposes of this disclosure the term “dimensional data” in relation to a term or query should be defined as an association between a term and a collection of information that defines a dimensional interpretation of that term. In some embodiments this may include references to logical distinctions, association qualifiers, or other variations and combinations of such. For example, term ‘London’ could be said to be associated with the dimension ‘place.’ Further, term ‘London’ could also be said to be 90% associated with the dimension ‘place’ and 10% associated with the dimension ‘individual:surname.’ Further, through inference or manual user interaction, these weightings could be altered, or even removed. Further, through inference or manual user interaction, an association could be modified to a Boolean ‘NOT.’ Further, through inference or manual user interaction, one or more terms could be associated as a set as collectively ‘AND’ or collectively ‘OR.’ One adequately skilled in the art can, of course, anticipate and apply numerous further logical iterations and variations on this theme.

For the purposes of this disclosure the term “facet casting” or “dimension(al) casting” in relation to a term or result indicates that a particular term has been either manually or automatically defined as targeting a specific search dimension. In some cases this may be synonymous with dimensional data in that it describes term meta data related to dimensional definitions. Unlike dimensional data, in some embodiments facet casting includes no connotation of weighting or exclusivity. For example, in one embodiment, the term “Washington” could be cast in the dimension of “place” indicating that it is focused on geography or map information. Alternatively “Washington” could be cast in the dimension of “person” indicating that is focused on biographical or similar information. Whereas dimensionality is an evolution of prior extant ideas (though not contained in those ideas) in the field regarding faceting, the term “dimensional casting” may be preferred, as “facet casting” may be, in some contexts, confused as to be limiting to the bounds of the traditional meaning of “facet.” In this disclosure any usage of the term “facet casting” or facet should be interpreted to include the broader meanings of “dimension” and “dimensional casting.”

For the purposes of this disclosure the term “disambiguation data” in relation to a term, query or result set connotes information that is intended to exclude overly broad interpretations of specific terms. For example, a common ambiguity encountered by IR systems is polysemy or homonymy. In one embodiment disambiguation data indicates one specific meaning or entity that is targeted by a term. For example, it may indicate that the term “milk” means the noun describing a fluid or beverage rather than the verb meaning “to extract.” In other embodiments this data may comprise information that defines one or more specific levels, contexts, classes or subclasses in an ontology or variable ontology. For example the term “milk” may be specified to mean the “beverage” subclass of a variable ontology, while simultaneously being indicated to mean the “fluid” subclass of the same variable ontology, while being indicated to mean the class “noun” (the parent class of fluid and beverage), while being excluded from the class “verb.” Similarly, this data may span multiple ontologies, category schemas or variable ontologies. For example, in the previous example, the term milk could also be indicated to belong to the class “product” in a second unrelated ontology as well as being categorized as “direct user entry” in a third categorization schema.

For the purposes of this disclosure the term “polysemy” connotes terms that have the capacity for multiple meanings or that have a large number of possible semantic interpretations. For example the word “book” can be interpreted as a verb meaning to make an action (to “book” a hotel room) or as a noun meaning a bound collection of pages, or as a noun meaning a text collected and distributed in any form. Polysemy is distinct, though related to, homonymy.

For the purposes of this disclosure the term “homonymy” connotes words that have the same construction and pronunciation but multiple meanings. For example the term “left” can mean “departed,” the past tense of leave, or the direction opposite “right.”

For the purposes of this disclosure the term “stop word” connotes words that occur so frequently in language that they are usually not very useful. For example, in many IR systems the word “the” as a search term is largely not useful for generating any meaningful results.

For the purposes of this disclosure the term “contextual data” in relation to a term or query connotes meta data that describes the context in which the query was entered into the system. In some embodiments, this may comprise, but is not limited to: demographic or account information about the user; information about how the user entered the UI of the system; information about other searches the user has conducted; information about other previous user interactions with the system; the time of day; the geolocation of the user; the “home” geolocation of the user; information about groups, networks or other contextual constructs to which the user belongs; previous disambiguation interactions of the user. In most embodiments this will be information that is stored chronologically separately from the interactions in which the query was formed.

For the purposes of this disclosure the term “contextual inference data” in relation to a term or query connotes meta data that describes the context in which the query was entered into the system. In some embodiments this can include all of the information described for contextual data, but also includes: information disambiguating the meaning of terms derived from semantic analysis or word context among the terms, plurality or subset of terms. In general contextual inference data differs from contextual data in that it is usually inferred from observation of the ‘current’ or recent user interactions with the system.

### Dimensional Articulation

Higher degrees of specificity can be accomplished in IR systems by increasing the degree of “dimensional articulation” or simply “articulation,” which, for the purposes of this disclosure connotes the degree to which terms have been contextually packaged with information that describes their relationship to, inclusion from or inclusion within search facets or search dimensions. This can be said to describe both the data stored about terms within the system, whether or not it is exposed to the user, and it can also be used to describe the degree to which this information is exposed to the user via the user interface. Additionally, this can be used to describe the degree to which artifacts collected within the system have been associated with one or more dimensions. The association of an artifact with a dimension, can, within the context of some IR systems be referred to as “tagging.” For example a given IR system could be described as being highly dimensionally articulated in its analysis of terms for producing query results, but having low dimensional articulation in its user interface. In either case, in many embodiments, the functional realization of that depth of articulation may be dependent upon the degree to which the artifacts are dimensionally articulated (tagged or associated with one or more dimensions).

For the purposes of this disclosure the term “fixed articulation” or “fixed” in reference to a term's dimensional articulation, especially, though not exclusively to its exposure in the UI of the IR system connotes dimensional articulation that is characterized, in various embodiments, by at least one of the following or similar: applied to only one dimension; applied to only a single class or subclass of a dimensional ontology (fixed or variable); provides a very limited number of value options; includes or uses terms that can only be applied to one or few dimensions; does not permit the transference of a term from one dimension to another; in any other way does not conform to the connotations of flexible articulation; in some embodiments do not (or do not clearly) expose to the user the manner in which the term's dimensionality is articulated.

For the purposes of this disclosure the terms “variable articulation” or “flexible articulation” in reference to a term connote an IR system and/or IR system user interface that includes some or all of the following: facet term linking; dimensional mutability; facet weighting; dimensional intersection; dimensional exclusion; contextual facet casting; facet inference; facet hinting; facet exposure; manual facet interaction; facet polyschema; facet Boolean logic. An IR system that exhibits several or all of these characteristics can be said to have high dimensional articulation and to have a high degree of specificity.

For the purposes of this disclosure the term “facet term linking” (or “dimensional term linking”) connotes a form of dimensional articulation in which search terms have one or more association with a search dimension. This enables terms to express greater specificity within a search query and to provide more powerful information need correlation. This enables the IR system to provide improved information conveyance to the user and to improve specificity and information need correlation.

For the purposes of this disclosure the term “dimensional mutability” connotes a form of dimensional articulation in which search terms may manually or automatically have their association with a search dimension changed to a different or a null association. This enables the quick translation, correction, disambiguation or alteration of a term from one dimension to another. This enables the IR system to provide improved information conveyance to the user and to improve specificity and information need correlation.

For the purposes of this disclosure the term “facet weighting” (or “dimensional weighting”) connotes a form of dimensional articulation in which a search term's dimensional association(s) may also be associated with a particular relative or absolute weight. Any number of generic or scaled weights may be used. This enables the IR system to improve specificity and information need correlation.

For the purposes of this disclosure the term “dimensional intersection” connotes a form of dimensional articulation in which search terms with dimensional data may be combined as terms within a single query so that each included term is collectively associated with a Boolean “AND”; this could also be described as a conjunctive association or simply as conjunction. This enables terms to express an information need that spans two or more verticals or dimensions in a single search query and to improve specificity and information need correlation.

For the purposes of this disclosure the term “dimensional exclusion” connotes a form of dimensional articulation in which search terms with dimensional associations may be associated with a Boolean “NOT”; this could also be described as a negative association or negation. Such terms act as negative influences for relevance returns. This enables terms to specifically express the exclusion of artifact evidence that corresponds to the term and to improve specificity and information need correlation.

For the purposes of this disclosure the term “contextual facet casting” (or “contextual dimensional casting”); connotes a form of dimensional articulation in which the terms and implicit or tacit dimensional association of terms in the query or a subsection of the query may influence the manner in which the facet inference or facet hinting occurs. This enables the IR system to provide improved information conveyance to the user and to improve specificity and information need correlation.

For the purposes of this disclosure the term “facet inference” (or “dimensional inference”) connotes a form of dimensional articulation in which search terms entered into a query are analyzed by the IR system and automatically cast or hinted for casting in the most likely inferred dimension(s). This enables the IR system to provide improved information conveyance to the user and to improve specificity and information need correlation.

For the purposes of this disclosure the term “facet exposure” (or “dimensional exposure”) connotes a form of dimensional articulation in which search terms with dimensional association(s) have those associations exposed to the user. This enables the IR system to provide improved information conveyance to the user and to improve specificity and information need correlation.

For the purposes of this disclosure the term “facet hinting” (or “dimensional hinting”) connotes a form of dimensional articulation in which suggested search dimension associations are displayed for each term in the query and which the user may interact with tacitly or implicitly to approve, accept or modify the suggested casting. This enables the IR system to provide improved information conveyance to the user and to improve specificity and information need correlation.

For the purposes of this disclosure the term “manual facet interaction” (or “manual dimensional interaction”) connotes a form of dimensional articulation in which the facet casting of search terms may be manually modified by the user of the IR system. This enables the IR system to improve specificity and information need correlation.

For the purposes of this disclosure the term “facet polyschema” (or “dimensional polyschema”) connotes a form of dimensional articulation in which search terms may be cast across dimensions belonging to various organizational schemas within the same query. This enables the IR system to improve specificity and information need correlation.

For the purposes of this disclosure the term “facet Boolean logic” (or “dimensional Boolean logic”) connotes a form of dimensional articulation in which the dimensional associations of search terms may also include associations with Boolean operators (conjunction (AND), disjunction (OR) or negation (NOT). This enables the IR system to improve specificity and information need correlation.

For the purpose of this disclosure the term “set” connotes a collection of defined and distinct objects that can be considered an object unto itself.

For the purpose of this disclosure the term “union” connotes a relationship between sets, which is the set of all objects that are members of any subject sets. For example, the union of two sets, A{1,2,3} and B{2,3,4} is the set {1,2,3,4}. The union of A and B can be expressed as “A∪B”.

For the purpose of this disclosure the term “intersection” connotes a relationship between sets, which is the set of all objects that are members of all subject sets. For example, the intersection of two sets, A{1,2,3} and B{2,3,4} is the set {2,3}. The intersection of A and B can be expressed as “A∩B”.

For the purpose of this disclosure the term “set difference” connotes a relationship between sets, which is the set of all members of one set that are not members of another set. For example, the set difference from set A{1,2,3} of set B{2,3,4} is the set {1}. Inversely, the set difference from set B{2,3,4} of set A{1,2,3} is the set {4}. The set difference from A of B can be expressed as “A\B”. “Set difference” can be synonymous with the terms “complement” and “exclusion.”

For the purpose of this disclosure the term “symmetric difference” connotes a relationship between sets, which is the set of all objects that are a member of exactly one of any subject sets. For example, the symmetric difference of two sets, A{1,2,3} and B{2,3,4}, is the set {1,4}. The set difference of sets A and B can be expressed as “(A∪B)\(A∩B).” “Symmetric difference” is synonymous with the term “mutual exclusion.”

For the purpose of this disclosure the term “cartesian product” connotes a relationship between sets, which is the set of all possible ordered pairs from the subject sets (or sequences of n length, where n is the number of subject sets), where each entry is a member of its relative set. For example, the Cartesian product of two sets, A{1,2} and B{3,4} is the set ({1,3},{1,4},{2,3},{2,4}).

For the purpose of this disclosure the term “power set” connotes a set whose members are all subsets of a subject set. For example, the power set of set A{1,2,3} is the set ({1},{2},{3},{1,2},{1,3},{2,3},{1,2,3}).

For the purpose of this disclosure the terms “conjunctive” and “Boolean AND” connote the Boolean “AND” operator, connoting an operation on two logical input values which produces a true result value if and only if both logical input values are true. This is synonymous with the term “Boolean AND” and can be notated in a number of ways, including “aΛb,” “Kab”, “a && b” or “a and b.”

For the purpose of this disclosure the terms “disjunctive” and “Boolean OR” connote the Boolean “OR” operator, connoting an operation on two logical input values which produces a false result value if and only if both logical input values are false. This is synonymous with the term “Boolean OR” and can be notated in a number of ways, including “aVb,” “Aab”, “a∥b” or “a or b.”

For the purpose of this disclosure the terms “negative” and “Boolean NOT” connote the Boolean “NOT” operator, connoting an operation on a single logical input value which produces a result value of true when the input value is false and a result value of false when the input value is true. This is synonymous with the concept of “negation” or “logical complement” and can be notated in a number of ways, including “ [symbol] a”, “Na”, “!a” or “not a”.

Search queries of greater specificity may be achieved by the utilization of various forms of organization of search dimensions. These are variously expressed in embodiments of the current invention as categories, schemas, ontologies, taxonomies, folksonomies, fixed vocabularies and variable vocabularies.

For the purposes of this disclosure, the term “schema” connotes a system of organization and structure of objects, which are comprised of entities and their associated characteristics. A schema may be said to describe a database, as in a conceptual schema, and may be translated into an explicit mapping within the context of a database management system. A schema may also be said to describe a system of entities and their relationships to one another; such as a collection of tags used to describe content or a hierarchy of types of artifacts. A schema may also include structure or collections regarding metadata, or information about artifacts. For example, schema.org or the Dublin Core Metadata Initiative.

For the purposes of this disclosure, the term “ontology” connotes a system of organization and structure for all artifacts that may be addressed by an IR system, including how such entities may be grouped, related in a hierarchy and subdivided or differentiated based on similarities or differences. Ontologies may comprise, in part, categories or classes or types, which may be subdivided into sub-categories or sub-classes or sub-types, which may be further divided into further sub-categories or sub-classes or sub-types, etc. For example, one ontology could include the classes trees and rocks; the class trees could include the subclasses, deciduous and evergreen; the sub-class deciduous could include the sub-classes oaks and elms; and so on. Given ontologies may be described as fixed, to rely on a fixed vocabulary and to have a known, finite number of classes. Given ontologies may also be described as variable, to rely on a variable vocabulary and to have an unknown, theoretically infinite number of classes. Ontologies are often hierarchical structures that can be used in concert with one another in order to provide a clear definition of a concept, object or subject. For example, the scientist Albert Einstein could be simultaneously defined in one ontology as “homo sapiens” while being defined in others as “physicist,” “German,” “former Princeton faculty,” and “male” in others. Similarly, the same subject, concept or object could be associated with multiple classes in the same ontology. Leonardo da Vinci could be simultaneously associated within a single ontology with “sculptor,” “architect,” “painter,” “engineer,” “musician,” “botanist” and “inventor” (as well several others).

The term “taxonomy” is closely related to ontology. For the purposes of this disclosure the distinction between taxonomy and ontology is that within the context of a single taxonomy, an object, subject or concept can be classified only once, as opposed to ontology, where an object may be associated with multiple types, classes or categories.

For the purpose of this disclosure the term “vocabulary” connotes a collection of descriptive information labels that are associated with underlying categories, types or classes; the referent article to a given search dimension or search dimension value. Vocabularies are usually, but not always comprised of words or terms. For example “red,” “mineral” and “dead English poets” could all be examples of items in a vocabulary. Alternative vocabularies can include or be comprised of other objects or forms of data. For example, an embodiment of the current invention could utilize a vocabulary that included the entity “FF0000,” the hexadecimal value for pure red color in an HTML document.

For the purpose of this disclosure the term “fixed vocabulary” connotes a vocabulary that that is generally established and remains unchanged over time. While some editing or updating of a fixed vocabulary may take place over the lifetime of an IR systems, the concept of these vocabularies is that they remain constant over time. Fixed vocabularies are usually, but not always, also controlled vocabularies.

Inversely, the term “variable vocabulary” connotes a volatile or dynamic vocabulary; one that changes over time, or grows dynamically as more items are added to it. Such vocabularies will likely vary substantially when sampled at one time or another during the life of an IR system. Variable vocabularies are usually, but not always, uncontrolled vocabularies.

For the purpose of this disclosure the term “controlled vocabulary” connotes a vocabulary that is created and maintained by administrative users of an IR system, as opposed to the search users of the IR system.

For the purpose of this disclosure the term “uncontrolled vocabulary” connotes a vocabulary that is created and maintained by the search users of the IR system, or the evidence that is acquired by the IR system about the artifacts it retrieves and analyzes.

For the purpose of this disclosure the term “dictionary” connotes a vocabulary that couples labels with definitions; i.e. signs with denotata. Each label may be associated with one or more definitions, and it is possible that one or more labels may be associated with the same or indistinguishable definitions (e.g. Polysemic or Homonymic labels).

It should be noted that dictionaries and vocabularies are typically conceived in a manner that is without hierarchy. In other words, though the definition of the label (or sign) ‘anatomy’ may have a relationship to the definition of ‘biology,’ the organization of the structure of the vocabulary or dictionary does not recognize this hierarchical relationship.

For the purposes of this disclosure the term “variable exclusivity” connotes an organizational system in which categories may either be mutually exclusive or inclusion permissive. Mutually exclusive categories are two or more categories with which a given artifact may be associated with only one, but not another. For example, an Internet page might be categorized as “child pornography” or “childrens' literature,” but it cannot be both. Inclusion permissive categories are two or more categories with which a given artifact may be associated with two or more. For example a given artifact might be categorized as “subject.medicine.pharmaceutical” and “segment.retail” without conflict. A preferred embodiment is to allow the default state of all categories to be inclusion permissive unless specifically configured otherwise, but it is also possible to make the default state of a category mutually exclusive.

For the purposes of this disclosure, within the context of describing categorical structure the term “flat” connotes un-hierarchical structures; generally having little or no ‘levels’ or hierarchy of classification, i.e. a structure which contains no substructure or subdivisions.

For the purposes of this disclosure, within the context of describing categorical structure the term “hierarchical” connotes structures that are modeled as a hierarchy; an arrangement of concepts, classes or types in which items may be arranged to be ‘above’ or ‘below’ one another, or ‘within’ or ‘without’ one another. In this context, one may speak of ‘parent’ or ‘child’ items, and/or of nested or branching relationships.

For the purposes of this disclosure, within the context of describing categorical structure, the terms “loose” or “unorganized” connote an organization, ontology, vocabulary, schema or taxonomy that has little or no hierarchy and is likely to contain multiple unassociated synonymous items.

For the purposes of this disclosure, within the context of describing categorical structure, the term “organized” connotes an organization, ontology, vocabulary, schema or taxonomy that has clearly defined hierarchy, tends not to contain synonymous items and/or, to the extent that it does contain multiple synonymous items, those items are associated with one another, so that potential ambiguities of association are avoided.

For the purposes of this disclosure the term “folksonomy” connotes a system of classification that is derived either from the practice and method of collaboratively creating and managing a collection of categorical labels, frequently referred to as “tags,” for the purposes of annotating and categorizing artifacts, and/or is derived from a set of categorical terms utilized by members of a specific defined group. Folksonomies are generally unstructured and flat, but variants can exist that are hierarchical and organized. Folksonomies tend to be comprised of variable vocabularies, though instances of fixed vocabularies being utilized with folksonomies also exist.

Examples of IR systems with low dimensional articulation include the search portals Google or Bing. When using one of these systems the user by default is exposed to a general “Search” vertical category. The user may select one of several other verticals such as “News” or “Images.” While initially entering terms the user may interact with the text entry box hints to disambiguate or in some cases, make limited dimensional distinctions, but in general lacks control, exposure and/or interactions that enable the user to understand, modify, manipulate or fully express any dimensional information. After entering terms or selecting a vertical, the user, in some cases, may be provided with additional fixed articulation for some dimensions that are salient within the selected vertical. For example, within images, users are provided with additional dimensional or facet inputs on the left part of the screen that enable dimensional interactions with “time,” “size,” “color” etc. The articulation of these dimensional inputs is entirely fixed. While a large number of dimensions are exposed within the overall UI of the search portal, only one categorical dimension (which in this case is synonymous with “vertical”) can be selected at a time.

Customarily, relevance is used solely as a measure of quality for results generated by an IR system. However, in context with systems that provide high degrees of dimensional articulation, relevance is also a measure of the quality of a number of system characteristics other than results generation, including facet casting, information conveyance and specificity. More relevant facet casting results in a higher correlation between a query and a user's information need. Apparatuses and processes that generate facet casting, facet inference, facet exposure and facet hinting may rely on relevancy processes and algorithms similar to those used to generate results (i.e. select and rank artifacts) in an IR system. Increased relevance that produces more intuitive, easy to understand, and contextually accurate responses within UI features related to dimensional articulation increase the quality of information conveyance to the user, which has a cascading effect on the quality of queries (specificity) entered by the user, concurrently and in future interactions. These processes and effects form a feedback loop which raises awareness and understanding on the part of the user about how the IR system operates while also raising the quality of results generated by the IR system, including precision, user relevance, topical relevance, boundary relevance, single and multi-dimensional relevance, higher correlation between information need and results related to recency and higher correlation between information need and results in general.

### Result Quality Measures

Relevance is often thought of as the primary measure of IR system result quality. Relevance is in practice a frequently intuitive measure by which result artifacts are said to correspond to the query input by a user of the IR system. While there are a number of abstract mathematical measures of relevance that can be said to precisely evaluate relevance in a specific and narrow way; their utility is demonstrably limited when considered alongside the opaque (at time of use) and complex decision making, assumptions and inferences made by a user when assembling a query. A good working definition of relevance is a measure of the degree to which a given artifact contains the information the user is searching for. It should also be noted that in some embodiments relevance can also be used to describe aspects of inference or disambiguation cues provided to the user to better articulate the facet casting or term hinting provided to the user in response to direct inputs.

Two common measures of evaluating the quality of relevance are “precision” and “recall.” Precision is the proportion of retrieved documents that are relevant (P=Re/Rt where P is precision, Re is the total number of retrieved relevant artifacts and Rt is the total number of all retrieved artifacts). Recall is the proportion of relevant documents that are retrieved of all possible relevant documents (R=Re/Ra where R is recall, Re is the total number of retrieved relevant artifacts and Rt is the total number of all possible relevant artifacts). Precision and recall can be applied as quality measures across a number of relevance characteristics.

The degree to which a retrieved artifact matches the intent of the user is often called “user relevance.” User relevance models most often rely on surveying users on how well results correspond to expectations. Sometimes it is extrapolated based on click-through or other metrics of observed user behavior.

Another set of relevance measures can be built around “topical relevance.” This is the degree to which a result artifact contains concepts that are within the same topical categories of the query. While topical can sometimes correspond with user intent, a result can be highly topically relevant and not represent the intent of the user at all. Alternatively, if a multi-faceted IR system is employed, this could be expressed as the proportion of defined topical categories for which an artifact is relevant to the total number of topical categories that were defined.

Another set of relevance measures can be built around “boundary relevance.” This is the degree to which a result artifact is sourced from within a defined boundary set characteristic. Alternatively, this could be expressed as the number of discrete organizational boundaries that must be crossed (or “hops”) from within a defined boundary set characteristic to find a given artifact (e.g. degrees of separation measured in a social network). Alternatively, this could be expressed as the subset of multiple boundary sets met by a given artifact.

If an IR system utilizes faceted term queries (that is, evaluates relevance against isolated meta-data stored about an artifact rather than the entire content of an artifact), then it can also utilize quality metrics that measure “single dimensional relevance;” that is, the degree to which result artifact corresponds to the query within the context of a given dimension. For example, if a search utilizes a geo-dimension and a user inputs a particular zip code, a given result can be measured by the absolute distance between its geo-location to that of the query. A collection of single dimensional relevance scores can be collected, weighted and aggregated to measure “multi-dimensional relevance.”

Other forms of quality measurement for IR systems focus on how rapidly new content can be added to the system, or, in cases where relevant, how quickly old content falls off or phases out of the system. “Coverage” measures how much of the extant accessible content that exists within the aggregate boundary set(s) of the system has been retrieved, analyzed and made available for retrieval by the system. “Freshness” (or sometimes “Recency”) measures the ‘age’ of the information available for retrieval in the system.

Another form of quality measurement is the degree to which—spam has penetrated the system. “Spam” refers to artifacts that contain information that distorts the evidence produced by the IR system. This is often described as misleading, inappropriate or non-relevant content in results. This is typically intentional and done for commercial gain, but can also occur accidentally, and can occur in many forms and for many reasons. “Spam Penetration” measures the proportion of spam artifacts to all returned artifacts.

Still other qualitative and subjective methods exist to measure the performance of an IR system. These include but are not limited to: efficiency, scalability, user experience, page visit duration, search refinement iterations and others.

### Curation

“Curation” is a discriminatory activity that selects, preserves, maintains, collects, and stores artifacts. This activity can be embodied in a variety of systems, processes, methods and apparatuses. Stored artifacts may be grouped into ontologies or other categorical sets. Even if only implicit, all IR systems use some form of curation. At the simplest level this could be the discriminatory characteristic of an IR system that determines it will only retrieve HTML artifacts while all other forms of artifact are ignored. More complex forms of curation rely on machine intelligence processes to categorize or rank artifacts or sub-elements of artifacts against definitions, rules or measures of what determines if an artifact belongs to a particular category or class. This could, for example, determine what artifacts are considered “news” and what artifacts are not. In some embodiments, the process of curation is referred to as “tagging.”

In some embodiments curation depends on automated machine processes. Methods such as clustering, Bayesian Analysis and SVM are utilized as parts of systems that include these processes. For purposes of this disclosure, the term “machine curation” will be used to identify such processes.

In some embodiments, curation is performed by human beings, who may interact with an IR system to indicate whether a given artifact belongs to a particular category or class. For purposes of this disclosure, the term “human curation” will be used to identify such processes.

In some embodiments, curation may be performed in an intermingled or cooperative fashion by machine processes and human beings interacting with machine processes. For purposes of this disclosure, the term “hybrid curation” will be used to identify such processes.

“Sheer curation” is a term that describes curation that is integrated into an existing workflow of creating or managing artifacts or other assets. Sheer curation relies on the close integration of effortless, low effort, invisible, automated, workflow-blocking or transparent steps in the creation, sharing, publication, distribution or management of artifacts. The ideal of sheer curation is to identify, promote and utilize tools and best practices that enable, augment and enrich curatorial stewardship and preservation of curatorial information to enhance the use of, access to and sustainability of artifacts over long and short term periods.

“Channelization” or “channelized curation” refers to continuous curation of artifacts as they are published, rendering steady flows of content for various forms of consumption. Such flows of content are often referred to as “channels.”

### Natural Language Processing

The term “natural language processing” or “NLP” connotes a field of computer science, artificial intelligence, and linguistics concerned with the interactions between computers and human (natural) languages. As such, NLP is related to the area of human-computer interaction.

The term “natural language understanding” is a subtopic of natural language processing in artificial intelligence that deals with machine reading comprehension. This may comprise conversion of sections of text into more formal representations such as first-order logic structures that are easier for computer programs to manipulate. Natural language understanding involves the identification of the intended semantic from the multiple possible semantics which can be derived from a natural language expression which usually takes the form of organized notations of natural languages concepts.

The term “machine reading comprehension” or “reading comprehension” connotes the level of understanding of a text/message or human language communication. This understanding comes from the interaction between the words that are written and how they trigger knowledge outside the text/message.

The term “automatic summarization” connotes the production of a readable summary of a body of text. Often used to provide summaries of text of a known type, such as articles in the financial section of a newspaper.

The term “coreference resolution” connotes a process that given a sentence or larger chunk of text, determines which words (“mention”) refer to the same objects (“entities”).

The term “anaphora resolution” connotes an example of a coreference solution that is specifically concerned with matching up pronouns with the nouns or names that they refer to.

The term “discourse analysis” connotes a number of methods related to: identifying the discourse structure of subsections of text (e.g. elaboration, explanation, contrast); or recognizing and classifying the speech acts in a subsection of text (e.g. yes-no question, content question, statement, assertion, etc.).

The term “machine translation” connotes the automated translation of text in one language into text with the same meaning in another language.

The term “morphological segmentation” connotes the sorting of words into individual morphemes and identification of the class of the morphemes. The difficulty of this task depends greatly on the complexity of the morphology (i.e. the structure of words) of the language being considered. English has fairly simple morphology, especially inflectional morphology, and thus it is often possible to ignore this task entirely and simply model all possible forms of a word (e.g. “open, opens, opened, opening”) as separate words. In languages such as Turkish, however, such an approach is not possible, as each dictionary entry has thousands of possible word forms.

The term “named entity recognition” or “NER” connotes the determination of which items in given text map to proper names, such as people or places, and what the type of each such name is (e.g. person, location, organization).

The term “natural language generation” connotes the generation of readable human language based on stored machine values from a machine readable medium.

The term “part-of-speech tagging” connotes the identification of the part of speech for a given word. Many words, especially common ones, can serve as multiple parts of speech. For example, “book” can be a noun (“the book on the table”) or verb (“to book a flight”); “set” can be a noun, verb or adjective; and “out” can be any of at least five different parts of speech. Note that some languages have more such ambiguity than others. Languages with little inflectional morphology, such as English are particularly prone to such ambiguity. Chinese is prone to such ambiguity because it is a tonal language during verbalization. Such inflection is not readily conveyed via the entities employed within the orthography to convey intended meaning.

The term “parsing” in the context of NLP or NLP related text analysis may connote the determination of the parse tree (grammatical analysis) of a given sentence. The grammar for natural languages is ambiguous and typical sentences have multiple possible analyses. In fact, perhaps surprisingly, for a typical sentence there may be thousands of potential parses (most of which will seem completely nonsensical to a human).

The term “question answering” connotes a method of generating an answer based on a human language question. Typical questions have a specific right answer (such as “What is the capital of Canada?”), but sometimes open-ended questions are also considered (such as “What is the meaning of life?”).

The term “relationship extraction” connotes a method for identifying the relationships among named entities in a given section of text. For example, who is the son of whom?)

The term “sentence breaking” or “sentence boundary disambiguation” connotes a method for identifying the boundaries of sentences. Sentence boundaries are often marked by periods or other punctuation marks, but these same characters can serve other purposes (e.g. marking abbreviations).

The term “sentiment analysis” connotes a method for the extraction of subjective information usually from a set of documents, often using online reviews to determine “polarity” about specific objects. It is especially useful for identifying trends of public opinion in the social media, for the purpose of marketing.

The term “speech recognition” connotes a method for the conversion of a given sound recording into a textual representation.

The term “speech segmentation” connotes a method for separating the sounds of a given a sound recording into its constituent words.

The term “topic segmentation” and/or “topic recognition” connotes a method for identifying the topic of a section of text.

The term “word segmentation” connotes the separation of continuous text into constituent words. Word segmentation: Separate a chunk of continuous text into separate words. For a language like English, this is fairly trivial, since words are usually separated by spaces. However, some written languages like Chinese, Japanese and That do not mark word boundaries in such a fashion, and in those languages text segmentation is a significant task requiring knowledge of the vocabulary and morphology of words in the language.

The term “word sense disambiguation” connotes the selection of a meaning for the use of a given word in a given textual context. Many words have more than one meaning; we have to select the meaning which makes the most sense in context.

### Human Machine Interaction

The term “Human-Machine Interaction” (or “human-computer interaction,” “HMI” or “HCI”) connotes the study, planning, and design of the interaction between people (users) and computers. It is often regarded as the intersection of computer science, behavioral sciences, design and several other fields of study. In complex systems, the human-machine interface is typically computerized. The term connotes that, unlike other tools with only limited uses (such as a hammer, useful for driving nails, but not much else), a computer has many affordances for use and this takes place in an open-ended dialog between the user and the computer.

The term “Affordance” connotes a quality of an object, or an environment, which allows an individual to perform an action. For example, a knob affords twisting, and perhaps pushing, while a cord affords pulling. The term is used in a variety of fields: perceptual psychology, cognitive psychology, environmental psychology, industrial design, human-computer interaction (HCI), interaction design, instructional design and artificial intelligence.

The term “Information Design” is the practice of presenting information in a way that fosters efficient and effective understanding of it. The term has come to be used specifically for graphic design for displaying information effectively, rather than just attractively or for artistic expression.

The term “Communication” connotes information communicated between a human and a machine; specifically a human-machine interaction that occurs within the context if a user interface rendered and interacted with on a computing device. This term can also connote communication between modules or other machine components.

The term “User Interface” (UI) connotes the space where interaction between humans and machines occurs. The goal of this interaction is effective operation and control of the machine on the user's end, and feedback from the machine, which aids the operator in making operational decisions. A UI may include, but is not limited to, a display device for interaction with a user via a pointing device, mouse, touchscreen, keyboard, a detected physical hand and/or arm or eye gesture, or other input device. A UI may further be embodied as a set of display objects contained within a presentation space. These objects provide presentations of the state of the software and expose opportunities for interaction from the user.

The term “User Experience” (“UX” or “UE”) connotes a person's emotions, opinions and experience in relation to using a particular product, system or service. User experience highlights the experiential, affective, meaningful and valuable aspects of human-computer interaction and product ownership. Additionally, it includes a person's perceptions of the practical aspects such as utility, ease of use and efficiency of the system. User experience is subjective in nature because it is about individual perception and thought with respect to the system.

“Cognitive Load” connotes the capacity of a human being to perceive and act within the context of human-machine interaction. This is a term used in cognitive psychology to illustrate the load related to the executive control of working memory (WM). Theories contend that during complex learning activities the amount of information and interactions that must be processed simultaneously can either under-load, or overload the finite amount of working memory one possesses. All elements must be processed before meaningful learning can continue. In the field of HCI, cognitive load can be used to refer to the load related to the perception and understanding of a given user interface on a total, screen, or sub-screen context. A complex, difficult UI can be said to have a high cognitive load, while a simple, easy to understand UI can be said to have a low cognitive load.

The term “Form” (in some cases “web form” or “HTML form”) generally connotes a screen, embodied in HTML or other language or format that allows a user to enter data that is consumed by software. Typically forms resemble paper forms because they include elements such as text boxes, radio buttons or checkboxes.

### Code

“Code” in the context of encoding, or coding system, connotes a rule for converting a piece of information (for example, a letter, word, phrase, or gesture) into another form or representation (one sign into another sign), not necessarily of the same type. Coding enables or augments communication in places where ordinary spoken or written language is difficult, impossible or undesirable. In other contexts, code connotes portions of software instruction.

“Encoding” connotes the process by which information from a source is converted into symbols to be communicated. (i.e. the coded sign)

“Decoding” connotes the reverse process, converting these code symbols back into information understandable by a receiver. (i.e. the information)

“Coding System” connotes a system of classification utilizing a specified set of sensory cues (such as, but not limited to color, sound, character glyph style, position or scale) in isolation or in concert with other information representations in order to communicate attributes or meta information about a given term object.

“Auxiliary Code Utilization” connotes the utilization of a coding system in a subordinate role to an other, primary method of communicating a given attribute.

“Code Set” in the context of encoding or code systems, connotes the collection of signs into which information is encoded.

“Color Code” connotes a coding system for displaying or communicating information by using different colors.

### Other Information

For the purposes of this disclosure the term “server” should be understood to refer to a service point which provides processing and/or database and/or communication facilities. By way of example, and not limitation, the term “server” can refer to a single, physical processor with associated communications and/or data storage and/or database facilities, or it can refer to a networked or clustered complex of processors and/or associated network and storage devices, as well as operating software and/or one or more database systems and/or applications software which support the services provided by the server.

For the purposes of this disclosure the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure the term “database”, “DB” or “data store” should be understood to refer to an organized collection of data on a computer readable medium. This includes, but is not limited to the data, its supporting data structures, logical databases, physical databases, arrays of databases, relational databases, flat files, document-oriented database systems, content in the database or other sub-components of the database, but does not, unless otherwise specified, refer to any specific implementation of data structure, database management system (DBMS).

For the purposes of this disclosure, a “computer readable medium” stores computer data in machine readable format. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer. The term “storage” may also be used to indicate a computer readable medium. The term “stored,” in some contexts where there is a possible implication that a record, record set or other form of information existed prior to the storage event, should be interpreted to include the act of updating the existing record, dependent on the needs of a given embodiment. Distinctions on the variable meaning of storing “on,” “in,” “within,” “via” or other prepositions are meaningless distinctions in the context of this term.

For the purposes of this disclosure a “module” is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

For the purposes of this disclosure a “social network” connotes a social networking service, platform or site that focuses on or includes features that focus on facilitating the building of social networks or social relations among people and/or entities (participants) who share some commonality, including but not limited to interests, background, activities, professional affiliation, virtual connections or affiliations or virtual connections or affiliations. In this context the term entity should be understood to indicate an organization, company, brand or other non-person entity that may have a representation on a social network. A social network consists of representations of each participant and a variety of services that are more or less intertwined with the social connections between and among participants. Many social networks are web-based and enable interaction among participants over the Internet, including but not limited to e-mail, instant messaging, threads, pinboards, sharing and message boards. Social networking sites allow users to share ideas, activities, events, and interests within their individual networks. Examples of social networks include Facebook, MySpace, Google+, Yammer, Yelp, Badoo, Orkut, LinkedIn and deviantArt. Social sharing networks may sometimes be excluded from the definition of a social network due to the fact that in some cases they do not provide all the customary features of a social network or rely on another social network to provide those features. For the purposes of this disclosure such social sharing networks are explicitly included in and should be considered synonymous with social networks. Social sharing applications including social news, social bookmarking, social/collaborative curation, social photo sharing, social media sharing, discovery engines with social network features, microblogging with social network features, mind-mapping engines with social network features and curation engines with social network features are all included in the term social network within this disclosure. Examples of these kinds of services include Reddit, Twitter, StumbleUpon, Delicious, Pearltrees and Flickr.

In some contexts the term “social network” may also be interpreted to mean one entity within the network and all entities connected by a specific number of degrees of separation. For example, entity A is “friends” with (i.e. has a one node or one degree association with) entities B, C and D. Entity D is “friends” with entity E. Entity E is “friends” with entity F. Entity G is friends with entity Z. “A's social network” without additional qualification, synonymous with “A's social network” to one degree of separation, should be understood to mean a set including A, B, C and D, where E, F, G and Z are the negative or exclusion set. “A's social network” to two degrees of separation should be understood to be a set including A, B, C, D and E, where F, G and Z are the negative or exclusion set. “A's social network” to various, variable or possible degrees of separation or the like should be understood to be a reference to all possible descriptions of “A's social network” to n degrees of separation, where n is any positive integer; in this case, depending on n, including up to A through F, but never G and Z, except in a negative or exclusion set.

The term “social network feed” connotes the totality of content (artifacts and meta-information) that appears within a given social network platform that is associated with a given entity. If associative reference is also given to artifacts via degrees of separation, that content is also included.

“Attributes” connotes specific data representations, (e.g. tuples <attribute name, value, rank>) associated with a specific term object.

“Name-Value Pair” connotes a specific type of attribute construction consisting of an ordered pair tuple (e.g. <attribute name, value>).

“Term Object” connotes collections of information used as part of an information retrieval system that include a term, and various attributes, which may include attributes that are part of a coding system related to this invention or may belong to other possible attribute sets that are unrelated to part of a coding system.

The term “sign” or “signifier” connotes information encoded in a form to have one or more distinct meanings, or denotata. In the context of this disclosure the term “sign” should be interpreted and contemplated both in terms of its meaning in linguistics and semiotics. In linguistics a sign is information (usually a word or symbol) that is associated with or encompasses one or more specific definitions. In semiotics a sign is information, or any sensory input expressed in any medium (a word, a symbol, a color, a sound, a picture, a smell, the state or style of information, etc.)

The term “denotata” connotes the underlying meaning of a sign, independent of any of the sensory aspects of the sign. Thus the word “chair” and a picture of a chair could both be said to be signs of the denotata of the concept of “chair,” which can be said to exist independently of the word or the picture.

The term “sememe” connotes an atomic or indivisible unit of transmitted or intended meaning. A sememe can be the meaning expressed by a morpheme, such as the English pluralizing morpheme—s, which carries the sememic feature [+plural]. Alternatively, a single sememe (for example [go] or [move]) can be conceived as the abstract representation of such verbs as skate, roll, jump, slide, turn, or boogie. It can be thought of as the semantic counterpart to any of the following: a meme in a culture, a gene in a genetic make-up, or an atom (or, more specifically, an elementary particle) in a substance. A “seme” is the name for the smallest unit of meaning recognized in semantics, referring to a single characteristic of a sememe. For many purposes of the current disclosure the term sememe and denotata are equivalent.

The term of “sememetically linked” connotes a condition or state where a given term is associated with a single primary sememe. It may also refer to a state where one or more additional alternative secondary (or alternative) sememe have been associated with the same term. Each associated primary or secondary sememe association may be scored or ranked for applicability to the inferred user intent. Each associated primary or secondary sememe association may also be additionally scored or ranked by manual selection from the user.

The term “sememetic pivot” describes a set of steps wherein a user tacitly or manually selects one sememetic association as opposed to another and the specific down-process effects such a decision has on the resulting artifact selection or putative artifact selection an IR system may produce in response to selecting one association as opposed to the other.

The term “state” or “style” in context of information connotes a particular method in which any form of encoding information may be altered for sensory observation beyond the specific glyphs of any letters, symbols or other sensory elements involved. The most readily familiar examples would be in the treatment of text. For example, the word “red” can be said to have a particular style in that it is shown in a given color, on a background of a given color, in a particular font, with a particular font weight (i.e. character thickness), without being italicized, underlined, or otherwise emphasized or distinguished and as such would comprise a particular sign with one or more particular denotata. Whereas the same word “red” could be presented with yellow letters (glyphs) on a black background, italicized and bolded, and thus potentially could be described as a distinct sign with alternate additional or possible multiple denotata.

The term “cognit” connotes a node in a cognium consisting of a series of attributes, such as label, definition, cognospect and other attributes as dynamically assigned during its existence in a cognium. The label may be one or more terms representing a concept. This also encompasses a super set of the semiotic pair sign/signifier—denotata as well as the concept of a sememe. (cognits—pl.)

The term “cognium”, “manifold variable ontology” or “MVO” connotes an organizational structure and informational storage schema that integrates many features of an ontology, vocabulary, dictionary and a mapping system. In an example embodiment a cognium is hierarchically structured like an ontology, though alternate embodiments may be flat or non-hierarchically networked. This structure may also consist of several root categories that exist within or contain independent hierarchies. Each node or record of a cognium is variably exclusive. In some embodiments each node is associated with one or more labels and the meaning of the denotata of each category is also contained or referenced. An example cognium is comprised of a collection of cognits that is variably exclusive and manifold; can be categorical, hierarchical, referential and networked. It can loosely be thought of as a super set of an ontology, taxonomy, dictionary, vocabulary and n-dimensional coordinate system. (cogniums—pl.)

Within a cognium of an example embodiment, the cognits inherit the following integrity restrictions.

Each cognit is identifiable by its attribute set, such as collectively the label, definition, cognospect, etc. The combination of attributes is required to be unique.

Each cognit must designate one and only one attribute as a unique identifier, this is considered a mandatory attribute and all other attributes are considered not mandatory.

Cognit attributes may exist one or more times provided the attribute and value pair is unique, for example the attribute “label” may exist once with the value “A” and again with the value “B”.

A cognit which does not have an attribute is not interpreted the same as a cognit which has an attribute with a null or empty value, for example cognit “A” does not have the “weight” attribute and cognit “B” has a “weight” attribute that is null, cognit “A” is said to not contain the attribute “weight” and cognit “B” is said to contain the attribute.

The definition of a cognit must be unique within its cognospect.

Relationships and associations designated hierarchical between cognits cannot create an infinite referential loop at any lineage or branch within the hierachy, for example cognit “A” has a parent “B” and therefore cognit “B” cannot have a parent “A”.

Relationships and associations not designated hierarchical between cognits can be infinitely referential, for example cognit “A” has a sibling “B’ and cognit “B” has a sibling “A’.

Only one relationship or association defined in a mutually exclusive group may appear between the same cognits, for example cognit “A” is a synonym of cognit “B” and therefore cognit “B” cannot be an antonym of cognit “A”.

Any relationship and association between cognits must be unique, i.e. not repeated and not redundant, for example cognit “A” is contained in cognit “B” may only exist once.

Relationships and associations defined in a mutually inclusive group will exist as a single relationship between cognits, for example if “brother”, “sister” and “sibling” are defined mutually inclusive, only one is designated for use.

Relationships and associations defined as hierarchical automatically define a mutually inclusive group to parent ancestry and all descendants, for example cognit “A” is a parent of cognit “B” and cognit “X” is a sibling of cognit “A” therefor cognit “X” also inherits all associations to the parent lineage of cognit “A” and all children and descendants of cognit “A”.

Relationships and associations defined in a rule set will be applied equally to all associated cognits, for example a rule which states all cognits associated with cognit “A” require a label attribute will cause the cognium to reject the addition of the relationship to cognit “B” until and unless a label attribute is defined on cognit “B”.

The term “cognology” connotes the act or science of constructing a cognium (cognological—adj, cognologies—pl.).

The term “cognospect” connotes the context of an individual cognit within a cognium. The context of a cognit may be identified by one or more attributes assigned to the cognit and when taken collectively with its label and definition, uniquely identify the cognit.

The usage of any terms defined within this disclosure should always be contemplated to connote all possible meanings provided, in addition to their common usages, to the fullest extent possible, inclusively, rather than exclusively.

One example embodiment incorporates the collection of a set of artifact records wherein the boundaries of that set are determined by the correlation of one or more query items with one or more cognits, and the selection of the set is determined by the correlation of artifact records with one or more cognits, and the selection of the set is modified or filtered by the correlation of artifact records with Boolean logic modifiers for one or more cognits. Such embodiments may incorporate varying forms of cognit and cognium structures, with components configured variously as methods, apparatuses or systems. Such embodiments may operate in the context of an information retrieval system, an information extraction system, a data mining system, other kinds of data or decision support systems, or other forms of data handling and organization systems which will be obvious to one skilled in the art.

One category of example embodiments incorporates the selection of one or more dimensional tags with the evaluation of one or more artifacts against one or more tag definitions, the association of one or more artifacts with one or more tags and wherein the association of tags and artifacts are governed by a machine decision. Such embodiments may incorporate one or more cogniums. Such embodiments may utilize one or more cognits as data elements. Such embodiments may operate in the context of an information retrieval system, an information extraction system, a data mining system, other kinds of data or decision support systems, or other forms of data handling and organization systems which will be obvious to one skilled in the art.

One category of example embodiments incorporates the selection of one or more dimensional tags with the evaluation of one or more artifacts against one or more tag definitions, the association of one or more artifacts with one or more tags and wherein the association of tags and artifacts are governed by a decision made by a human being. Such embodiments may incorporate one or more cogniums. Such embodiments may utilize one or more cognits as data elements. Such embodiments may incorporate processes where the human decision occurs prior to the storage of the association. Such embodiments may incorporate processes where the human decision is tacitly or actively recorded prior to the storage of the association. Such embodiments may incorporate processes where the human decision is applied after a previously acting machine process has recommended the association. Such embodiments may incorporate processes where an existing association is modified by a human decision. Such embodiments may incorporate processes where an existing association is removed (or broken) by a human decision. Such embodiments may operate in the context of an information retrieval system, an information extraction system, a data mining system, other kinds of data or decision support systems, or other forms of data handling and organization systems which will be obvious to one skilled in the art.

One category of example embodiments incorporates the collection of a set of inferred sememes, the selection of which is determined by one or more dimensionally articulated terms in a search query. Such embodiments may incorporate the utilization of a cognium as a data source. Such embodiments may incorporate the utilization of cognits as data sources for generating the set. Such embodiments may incorporate the utilization of one or more vocabularies as data sources for generating the set. Such embodiments may incorporate processes that order or rank the contents of the set based on degree of association or relative score of association with the dimensionally articulated search terms. Such embodiments may incorporate inferred sememes as pivoting hints within the system user interface. Such embodiments may determine the boundaries of the set using mode analysis of the current or putative artifact result set. Such embodiments may determine the boundaries of the set using cluster analysis of the current or putative artifact result set. Such embodiments may determine the boundaries of the set using pivot analysis of the current or putative artifact result set. Such embodiments may determine the boundaries of the set using mode analysis of the query. Such embodiments may determine the boundaries of the set using cluster analysis of the query. Such embodiments may determine the boundaries of the set using pivot analysis of the query. Such embodiments may operate in the context of an information retrieval system, an information extraction system, a data mining system, other kinds of data or decision support systems, or other forms of data handling and organization systems which will be obvious to one skilled in the art.

One category of example embodiments incorporates natural language processing of a submitted query with the selection of one or more root terms, the selection of one or more cognits in relation to the selected root terms, the selection of one or more logical attributes in relation to the selected cognits, the assembly of a dimensionally articulated query that incorporates the previous selections and the selection of a set of result artifacts based on the dimensionally articulated query. Such embodiments may utilize natural language methods incorporating natural language understanding techniques. Such embodiments may utilize natural language methods incorporating machine reading comprehension techniques. Such embodiments may utilize natural language methods incorporating coreference techniques. Such embodiments may utilize natural language methods incorporating anaphora resolution techniques. Such embodiments may utilize natural language methods incorporating discourse analysis techniques. Such embodiments may utilize natural language methods incorporating machine translation techniques. Such embodiments may utilize natural language methods incorporating morphological segmentation techniques. Such embodiments may utilize natural language methods incorporating named entity recognition techniques. Such embodiments may utilize natural language methods incorporating part of speech tagging techniques. Such embodiments may utilize natural language methods incorporating NLP parsing techniques. Such embodiments may utilize natural language methods incorporating question answering techniques. Such embodiments may utilize natural language methods incorporating relationship extraction techniques. Such embodiments may utilize natural language methods incorporating sentence boundary disambiguation techniques. Such embodiments may utilize natural language methods incorporating speech recognition techniques. Such embodiments may utilize natural language methods incorporating speech segmentation techniques. Such embodiments may utilize natural language methods incorporating word segmentation techniques. Such embodiments may utilize natural language methods incorporating word sense disambiguation techniques. Such embodiments may operate in the context of an information retrieval system, an information extraction system, a data mining system, other kinds of data or decision support systems, or other forms of data handling and organization systems which will be obvious to one skilled in the art.

One category of example embodiments incorporates the selection of one or more dimensional tags with the selection of one or more artifacts, the statistical analysis of the artifact selection to generate one or more patterns and the association of the selected dimensional tags, artifacts and patterns with one another. Such embodiments may be utilize data contained within a cognium apparatus. Such embodiments may perform selections of data contained within a cognium apparatus. Elements used in such embodiments may be in the form of cognits. Such embodiments may enable selection for association by algorithms. Such embodiments may enable selection for association by automated machine processes. Such embodiments may enable selections by machines to be modified by human beings. Such embodiments may enable selections by human beings to be modified by machines. Such embodiments may operate in the context of an information retrieval system, an information extraction system, a data mining system, other kinds of data or decision support systems, or other forms of data handling and organization systems which will be obvious to one skilled in the art.

One category of example embodiments incorporates the selection of one or more dimensional tags with the selection of one or more artifacts and the generation of a custom curation definition that associates the selected tags and artifacts. Such an embodiment may incorporate a human controlled machine process to initiate and configure the selection and association. Such an embodiment may incorporate an automated machine controlled process to initiate and configure the selection and association. Such an embodiment may incorporate an ad-hoc curation definition. Such an embodiment may enable the modification and/or duplication of an ad-hoc curation definition. Such an embodiment may utilize one or more cogniums to provide elements of the association. Such an embodiment may utilize one or more cognits to provide elements of the association. Such embodiments may operate in the context of an information retrieval system, an information extraction system, a data mining system, other kinds of data or decision support systems, or other forms of data handling and organization systems which will be obvious to one skilled in the art.

One category of example embodiments incorporates the selection of one or more dimensional tags with the selection of one or more labels (terms and/or root terms) and the selection of one or more role definitions wherein the selected one or more dimensional tags, labels and role definitions are associated with one another. Such embodiments may utilize dimensional tags that are constituent elements in one or more cognits. Such embodiments may utilized tags and labels that are contained in a cognium. Such embodiments may employ a process that selects one or more associations by utilizing role definitions as searchable keys. Such embodiments may operate in the context of an information retrieval system, an information extraction system, a data mining system, other kinds of data or decision support systems, or other forms of data handling and organization systems which will be obvious to one skilled in the art.

One category of example embodiments incorporates the selection of one or more root terms with the selection of one or more dimensional tags and the association of the root term(s) with the dimensional tag(s). Such an embodiment may utilize stemming techniques to decide whether or not to create the association. Such an embodiment may utilize lookup stemming techniques to decide whether or not to create the association. Such an embodiment may utilize suffix stripping stemming techniques to decide whether or not to create the association. Such an embodiment may utilize lemmatization stemming techniques to decide whether or not to create the association. Such an embodiment may utilize stochastic stemming techniques to decide whether or not to create the association. Such an embodiment may affix stemming techniques to decide whether or not to create the association. Such an embodiment may utilize matching stemming techniques to decide whether or not to create the association. Such embodiments may operate in the context of an information retrieval system, an information extraction system, a data mining system, other kinds of data or decision support systems, or other forms of data handling and organization systems which will be obvious to one skilled in the art.

One category of example embodiments incorporates the storage of a singular definition (a sememe), the storage of a label, the storage of a dimensional context and the association of the singular definition, the label and the dimensional context into a object called a cognit. Such an embodiment may incorporate one or a plurality of such cognits into an apparatus or system called a cognium. Such an embodiment may organize the cognits hierarchically. Such an embodiment may organize the cognits via peer associations. Such an embodiment may simultaneously utilize peer associations and hierarchical associations. Such an embodiment may compound multiple individual cogniums into a manifold system wherein cogniums may be selected or utilized in selected sets. Such embodiments may operate in the context of an information retrieval system, an information extraction system, a data mining system, other kinds of data or decision support systems, or other forms of data handling and organization systems which will be obvious to one skilled in the art.

One category of example embodiments incorporates the collection of a set of dimensional hints, including one or more of: a dimensional reference, a term, a logical attribute; and where the set is provided as hinting feedback within an information retrieval system. Such an embodiment may utilize a cognium as a data source in the generation of the set. Such an embodiment may utilize one or more cognits as data sources in the generation of the set. Such an embodiment may utilize one or more vocabularies, in isolation or concert, in the generation of the set. Such an embodiment may rely on data sources or algorithmic or other means to order or rank the contents of the set. Such an embodiment may determine the boundaries of the set using mode analysis of a current or putative result set. Such an embodiment may determine the boundaries of the set using cluster analysis of a current or putative result set. Such an embodiment may determine the boundaries of the set using pivot analysis of a current or putative result set. Such an embodiment may determine the boundaries of the set using mode analysis of the selected query or an associated query. Such an embodiment may determine the boundaries of the set using cluster analysis of the selected query or an associated query. Such an embodiment may determine the boundaries of the set using pivot analysis of the selected query or an associated query. Such embodiments may operate in the context of an information retrieval system, an information extraction system, a data mining system, other kinds of data or decision support systems, or other forms of data handling and organization systems which will be obvious to one skilled in the art.

### Interpretation Considerations

When reading this section (which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way. Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium, particularly control and detection/feedback methodologies. Computer-readable mediums include passive data storage, such as a random access memory (RAM) as well as semi-permanent data storage. In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to operate the methods of the invention. It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise.

The numerous innovative teachings of present application are described with particular reference to presently preferred embodiments.

### DESCRIPTION OF THE DRAWINGS

This invention comprises methods, variously and alternatively embodied as systems, processes, algorithms, and apparatuses that relate to dimensional articulation and cognium organization in information retrieval systems. These include, without limitation:

(a) The refinement, elucidation and presentation of dimensionally articulated controls in relation to input terms as well as providing a mechanism for inferring and providing interaction points for dimensional pivoting of search queries wherein dimensions incorporate one or more of: domain-specific topicality; artifact categoricality; source characteristics (such as region); universal domain topicality; contextual topicality; various forms of hierarchical and non-hierarchical organization of topicality or categoricality.

(b) Methods for utilizing cognium based dimensional data in the context of an information retrieval system. The employment of dimensional data produces improved specificity, information conveyance and a higher correlation of query formation to the information need of the user within the information retrieval system.

(c) Methods that enable hinting and inference processes for sememetic casting of terms within an IR system.

(d) Methods that enable machine and human collaboration on the creation, editing, maintenance, and evaluation of dimensional tag curation for indexed artifacts. As artifacts are provided for curation, automated machine processes associate dimensional tags to the artifact while providing detailed activity information to human curators. The automated processes use machine learning algorithms with information from previous curation activities and allow the human curators to modify the learning and control information in order to create a continuous collaborative feedback loop between the automated processes and human curators. This feedback loop refines automated machine processes to improve their accuracy and provides tools for human curators.

(e) Methods that enable an information retrieval system to dimensionally articulate the results of semantic analysis of an input query by analyzing a natural language query input in conjunction with a cognium and constituent cognits so that is usable in a dimensionally articulated IR system.

(f) Methods that enable creating, editing and using training artifact sets for dimensional curation in an IR system. Training artifacts can be identified and collected into sets to illustrate patterns in artifacts defining a dimensional tag. During artifact curation, i.e. the associating of dimensional tags to an artifact, the training artifact sets are applied to a target artifact using specified machine learning processes within the IR system for the purpose of determining whether a specific dimensional tag is appropriate to the target artifact.

(g) Methods that enable creating and editing custom curation definitions. Search queries, dimensional tags and/or specific artifacts are collected and assigned an identifier (label), called a custom curation definition. Custom curation definitions allow (machine and/or human) users of an IR system to control the search results from the system using predefined collections of artifacts. These artifact collections are a result of queries, custom dimensional tags and/or enumeration of specific artifacts. A custom curation definition may also be used as the bases for another search and/or combined with other custom curation definitions. The custom curation definition may also be edited dynamically during use, saved under a new identifier (label) and/or saved to overwrite the previous definition content.

(h) Methods for creating, maintaining and using role based indices in a dimensionally articulated IR system. Various searches and queries are performed for dimensional tags and dimensional tag attributes in addition to the expected keytext based searches. This is necessary to fully communicate the actions and behavior related to the use of dimensional tags prior to performed the primary query to retrieve desired artifacts. The dimensional tags and attributes may exist in one or more separate indices, each with a defined purpose and/or set or purposes, which may or may not mix or separate artifact content and dimensional tag content as dictated by the IR system.

(i) Methods for defining and performing stemming on dimensional tags. As artifacts are provided for curation, dimension tags are associated by providing, at a minimum, the applicable dimension name and the appropriate dimension value for each tag. The dimension names and values are reduced to roots during all processing to provide consistency across artifacts. Dimensional tag information provided by queries is processed in a similar way to ensure artifacts are accurately retrieved by an IR system.

(j) Methods for the use and definition of a cognium as a means of labeling to associate dimensional tags to any artifacts. Hierarchical structures, such as ontologies and taxonomies, definitional structures, such as vocabularies and dictionaries, and referential structures, such as thesaurus, are registered, maintained, annotated and harmonized within the cognium to provide the dimension axis labels upon which any artifact may be projected. Within the cognium all content is organized as needed and may include, but is not limited to, hierarchical, networked, categorical and referential relationships, used during system processing for the application of dimensional tags and labels.

(k) Methods for enabling hinting processes for refining, elucidating and interacting with dimensionally articulated controls in relation to terms within an information retrieval system as well as providing a mechanism for inferring and providing interaction points for dimensional pivoting within an IR system.

The present invention is described below with reference to block diagrams and operational illustrations of methods and devices related to the current invention. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

In many embodiments the processes disclosed here are performed within the context of a larger IR system, which may include a controller or other containing module. Where the specific methods disclosed here indicate a “Start” and/or “Stop” it may be inferred that this indicates where a controller initiates or receives notification of completion for a specific process. Thus, in any of these embodiments it can be inferred that a controller is involved, but is not required. The controller may be, but is not limited to, an internet browser, automated scheduling system or other human controlled machine process.

References below to any form of HMI may be embodied in either active or passive machine interactions. For example, a human interacting with a form or an automated process reacting to a broad record or history of human activity.

One example comprises a number of embodiments and utilizations of a cognium in the context of an IR system where it enables the generation of a collection of artifact records in response to a user query by means of mapping user information need via a cognium. In a preferred embodiment the cognium and data store that holds artifact records operate in the context of or as part of an apparatus that enables processes for identifying the precise information need of the user and to accordingly identify artifacts that match that expression of information need. In a preferred embodiment the cognium is recorded in a data store in the context of an IR system, where various related processes and other apparatuses and systems may interact with it. In each of these cases the term “artifact record” is referring to a collection of data that comprises a metadata description of derived characteristics of the artifact.

FIG. 101 illustrates an embodiment where an artifact record may include a collection of simple key value pairs [101.3], which identify a dimension (or more precisely, a cognit, representing a value in dimensional space; in the illustrated case a Boolean true relationship) that have a relationship (are associated) [101.2] with an artifact [101.1]. Each of these associated key value pairs are examples of some of the simplest embodiments of an artifact record. Each key value pair, in this case, consists of a key: a dimension ID (which could, in many embodiments be identical to a label, but in other embodiments be some form of unique identifier); and a Boolean value: (‘1’ or ‘0’) that operates as an expression of whether or not the associated artifact is or is not associated with the given dimension. It should be obvious to one skilled in the art examples could be alternately embodied as bits, strings, numeric or other types of values, codes or foreign keys.

FIG. 102 illustrates an embodiment where an artifact record consists of an artifact [102.1] associated [102.2] with one or more key value pairs [102.3, 102.4 102.5].

FIG. 103 illustrates an embodiment where an artifact record consists of an artifact [103.1] associated [103.2] with one or more tuples [103.3, 103.4, 103.5]. Each tuple, in this case, consists of three attributes or values: a dimension ID (which could, in many embodiments be identical to a label, but in other embodiments be some form of unique identifier); an expression of the strength of relation to the given dimension (i.e. strength of that association, strength of that tag, score for that association, score for that tag, relevance, etc.), in this case shown as a numeric value of ‘0’ to ‘100’; and a Boolean value (‘1’ or ‘0’) that operates as an expression of whether a human curator indicated that the associated artifact should be associated with the given dimension. It should be apparent to one skilled in the art how these specific example values could be alternately embodied as bits, strings, numeric or other types of values, codes or foreign keys. It should also be apparent to one skilled in the art that a single tuple could be associated in the same manner.

FIG. 104 illustrates an embodiment where an artifact record consists of an artifact [104.1] associated [104.2] with a tuple [104.3] that is also associated [104.4] with a record for a user or a group of users [104.5]. In this embodiment it can be seen how the attributes of the tuple can be applied to, or otherwise utilized in relation to a given user or group of users, or alternately be withheld or otherwise utilized apart from a given user or group of users.

FIG. 105 illustrates an embodiment where an artifact record consists of a simple associative array [105.1]. In this case the association with an artifact is embodied in the “artifact_id” element, with a unique identifier numeric value. The association with the dimension is embodied in the “dimensions” sub-array, in which it can be seen there is a single association with a dimension called “biology”, having a Boolean value of ‘1.’

FIG. 106 illustrates an embodiment where an artifact record consists of a simple associative array, but the dimensions sub-array [106.1], unlike that shown in [105.1], illustrates a case where the artifact is associated with more than one dimension, and further has a scored or ranked relationship with each associated dimension.

FIG. 107 illustrates an embodiment where an artifact record [107.1], consists of compound information about an artifact in an array, and a related record that extends the artifact record in the context of a particular user [107.2]. The three sub-arrays in [107.1] illustrate the principle that a given artifact record may contain information that contains variable or even contradictory expressions of relationships between an artifact and a given dimension, in this case it shows that a “machine_curated” process has resulted in one set of dimensional relationship expressions, while “human_curated” process and a “publisher_curated” process have resulted in two other sets of dimensional relationships. It should be clear to one skilled in the art that the publisher curated and human curated relationships are directly contrary to one another. This is indicative of the desire of the publisher of an artifact differing from an objective curation effort by a human. Also note that the scoring values stored by the machine curation process offer a more shaded interpretation. These alternative relationships expressed in the artifact record are useful in enabling various types of features via the IR system, especially those enabling the user to distinguish between the desires of a publisher, some third party curator, other users, algorithmic scores (i.e. machine curation) and other various forms of possible input that are apparent to one skilled in the art.

While there are a handful of data structure embodiments disclosed here (key value pair, tuples, and associative arrays) it should be readily apparent to one skilled in the art that various forms of alternate data store implementations could be made while preserving the functional attributes disclosed here.

Note: In many or all of illustrated embodiments one or more tuples or key value pairs are shown being associated with a single artifact. It should be clear to one adequately skilled in the art that such relationships could also be established with collections of artifacts or artifact references of various forms.

Note: Various embodiments may require the explicit exclusion of every possible dimensional association, though in most preferred embodiments non-association will be implicit by a lack of an association record. In other words, there is no requirement to have any record that explicitly denies a dimensional association, though there are cases where it may be desirable.

In a preferred embodiment, the cognospect of a given cognit is usually derived entirely by its position within the cognium hierarchy. Cognium hierarchies are, in some preferred embodiments organized as an ontology. By creating a relationship between an artifact and a dimension_id (which is a referent to a cognit) the artifact is also being described as having one or more corresponding expressions in dimensional space equivalent to any associated cognit.

FIG. 108 illustrates an embodiment of a cognium comprising cognits in the form of tuples. The organization of the attributes in each tuple are <unique ID, label, parent unique ID, definition>. The hierarchical structure of the cognium can be derived from this information in the tuples. Thus, it can be said that Cognit A [108.1] is the parent or root of Cognit B [108.2] and that Cognit B [108.2] is the parent or root of both Cognits C [108.3] and D [108.4]. While all the elements listed here would comprise a valid cognium in a plurality of example systems, in practice a cognium will tend to include many more cognits. It should also be noted that Cognit A [108.1] contains a ‘null’ value for parent unique ID—this indicates that is a root cognit; some embodiments of cogniums may contain one or more root cognits.

FIG. 109 illustrates an embodiment of a cognit as an associative array. In this illustration the cognits have the same hierarchy as in FIG. 108 (Cognit A [109.1] is the parent or root of Cognit B [109.2] and that Cognit B [109.2] is the parent or root of both Cognits C [109.3] and D [109.4].) But in this case the hierarchy is mapped via the contents of the label element.

FIG. 110 illustrates a subsection of an embodiment comprising the submission of search terms where each term is coupled with a given cognit. The process can be initiated by user interaction with a web site or other form of software [110.1]. The user enters a term [110.2]. The system responds by searching the cognium for a cognit that matches the term [110.4]. Note that a matching cognit could be on the basis of a number of matching criteria, including but not limited to, exact text match, word stemming, word branching, synonymy, etc. and must also take into account any specific logical attributes assigned to the term, including but not limited to Boolean ‘NOT’, Boolean ‘AND’, Boolean ‘OR’ etc. The IR system finds and returns one or more matching cognits. Though not strictly necessary, in a preferred embodiment, the returned cognits are sorted, ranked or scored by their likely applicability to the given term. The IR system then presents the returned cognit(s) to the user [110.4], enabling the user to passively accept the top ranked cognit, or alternatively to select one of the other possible cognits. The user may then elect to add a new term [110.5]. Note, this step also includes scenarios where the user may elect to alter the existing term—for the purpose of this process illustration, such an action is identical to adding a new term. If a new term is added [110.51], the process returns to step [110.2] and repeats the loop. Otherwise [110.52] the process proceeds submit the query [110.6] and ends, returning control of the process to the initiating software [110.7].

FIG. 111 illustrates the subsection of an embodiment process following the submission of a query. The process is initiated by the controlling software [111.1] by passing the query [111.2]. The IR system responds to the query first, by assembling a set of artifacts [111.3] which it accomplishes by finding all artifact records that correspond to the logical set defined by the plurality of terms and logical modifiers attached to terms. The system compares the logical set definition of the query with the artifact records contained in the artifact record index [111.4] and collects the appropriate set of records. The IR system next returns the set of records to the controlling software [111.4], terminating this part of the process [111.5].

In some embodiments additional cognit or cognit extension records are used, or additional vocabulary models may be employed, which enable the IR system's identification of cognit-term matches to proceed on the basis of word stemming, synonymy or other equivalency finding methods to identify matches. For example the term “zoological” might thus be matched with the cognit “zoology” in such an embodiment.

In other embodiments cognit modification data may be used (either internally to the cognit or in associated records) that support various aspects of variable exclusivity by blocking particular combinations of cognits in order to provide desirable user features. For example such an exclusivity record could make it impossible to return a set numbering greater than zero for a group of cognits including “children's literature” and “pornography.” The utilization and utility of such an embodiment will be obvious to those skilled in the art.

In some embodiments, creating a custom curation definition is a human controlled machine process [201]. The user initiates the creation process via a user interface (UI) starting with a blank entry form or canvas [201.1]. Optionally the cognium [201.31] is queried for existing custom curation definitions which will be used as a starting point or may be referenced from a new custom curation definition [201.10]. Also optionally, one or more existing artifacts may be specifically enumerated within the new custom curation definition [201.30]. Also optionally, one or more IR provided dimensional tags and/or custom dimensional tags may be included in the new custom curation definition [201.10]. Upon completion, a search may be performed using the new custom curation definition [201.10 & 201.11] to allow user verification that the custom definition is working as expected. The user may choose to refine the custom curation definition further [201.10], save the definition [201.11] and/or use the search results to apply custom dimensional tags and/or add the results to the definition [201.12]. Upon completion a response notification is sent to the initiating controller [201.2].

In some embodiments, creating a custom curation definition is an automated machine process [201]. The process is initiated by directives from the controller [201.1] which includes information necessary to define the breadth and scope of the creation process, including but not limited to, one or more existing custom curation definitions, one or more dimensional tags, one or more specific artifacts and/or one or more query clauses. The provided information is verified to the extent possible, including but not limited to application of machine learning techniques, for example, the statistical comparison of term usage in a collection of master learning material (artifacts) to sets of custom curated artifacts, and a search is performed [201.10]. Provided there are no query syntactical issues, the appropriate information is saved as originally directed [201.11 & 201.12]. Upon completion a response notification is sent to the initiating controller [201.2].

In some embodiments, editing a custom curation definition is a human controlled machine process [202]. The user initiates the editing process via a user interface (UI) [202.1]. An existing custom curation definition is found and retrieved from the cognium [202.10]. In some embodiments the user may change all elements of the definition, including but not necessarily limited to, the query clauses, the IR provided dimensional tags, the custom dimensional tags and the selected enumerated specific artifacts of interest [202.11 & 202.12]. Once editing is complete the changes may be saved back to the cognium using the original definition identifier (label) or as a new identifier (label) [202.11 & 202.12]. Upon completion a response notification is sent to the initiating controller [202.2].

In some embodiments, editing a custom curation definition is an automated machine process [202]. The process is initiated by directives from the controller [202.1] which includes information necessary to define the breadth and scope of the editing process, including but not limited to, changing references of one custom curation definition to another, changing references of one artifact to another, changing references of one dimensional tag to another and/or adding clauses to the query [202.11 & 202.12]. All edits are automatically saved back to the cognium as originally directed, for example a directive to overwrite the original definition with changes or a directive to save changes to a new custom curation definition by using a new custom curation definition identifier (label). Upon completion a response notification is sent to the initiating controller [202.2].

In some embodiments, using a custom curation definition is a human controlled machine process [203]. The user initiates a search in the IR system [203.1]. A custom curation definition is read and may be referenced, included (as a whole) or excerpted (in part) within the user specified query [203.10]. User dynamic changes are applied [203.11], this may include but is not necessarily limited to, deleting clauses contained in the custom curation definition which directly contradict and/or conflict with a user specific clause, adding specific artifact references not included in the custom curation definition and negating one or more dimensional tags [203.11]. After application of the dynamic changes the search is performed [203.12]. In a preferred embodiment, dynamic alterations of a custom curation definition are never saved or written back to the cognium. Upon completion a response notification is sent to the initiating controller [203.2].

In some embodiments, using a custom curation definition is an automated machine process [203]. The process is initiated by directives from the controller [203.1] which includes information necessary to identify the custom curation definition and define the breadth and scope of any dynamic edits. The specified custom curation definition(s) is (are) read from the cognium [203.10]. The directed dynamic alterations are applied [203.11], this may include but is not limited to, changing specific enumerated artifacts for the custom curation definition. The search is executed with the dynamic alterations [203.12]. Upon completion a response notification is sent to the initiating controller [203.2].

In some embodiments, curation [301] is performed by receiving an instruction [301.1] from a controller to evaluate an artifact retrieved from a data store [301.30] by applying a concept cognium and other control information [301.31] in a machine automated and human manual curation tagging process, which results in the storage of a tag associated with the artifact [301.10]. Upon completion a response notification is sent to the initiating controller [301.2].

The machine automated curation [302] is initiated [302.1] and begins by collecting cognium information from a data store [302.10] and the artifact from a data store for curation [302.11]. The artifact is evaluated against the cognium, via system methods and processes [302.12], to determine the appropriate dimensional tags applicable to the artifact. The possible dimensional tags are defined by the cognium and may include evaluation rules associated with each tag. The cognium may also define sets of tags for related concepts. The tags derived from the evaluation [302.12] define a dimensional tag set and actions which are logged [302.13 & 302.33] in a data store. The dimensional tag set is then evaluated against manual directives defined by human curators [302.14 & 302.32] as defined in a data store. An annotated copy of the artifact is saved back to a data store [302.15] to be indexed when scheduled by the controller [302.2].

The actions and tag sets resulting from automated processes are reviewed and corrections made as needed [303]. In some embodiments, the nature of the tag sets and actions log will cause automated notification to human curators to take corrective actions. In other embodiments, notification may not be automated [303.1]. A human curator will read the logged actions [303.10] and optionally the artifact originally evaluated [303.11] from a data store. Previous human curated manual instructions [303.12] from a data store may also be included, reviewed and updated as part of the corrective actions. Upon completion the logged actions are annotated by the human curator and written back to a data store [303.14]. Any updates made to the annotated artifact are also saved to a data store [303.15]. The controller will be notified the artifact is now ready for indexing [303.2].

Independent of corrections indicated by the action log, the human curator may create, change or delete instructions to future machine automated curation [304]. The human curator will select zero, one or more existing instructions from a data store [304.10] and optionally one or more desired artifacts from a data store [304.11]. Rules to add or delete dimensional tags can be created and changed [304.12 & 304.13] as necessary. Upon completion the human curator may save the edits to a data store [304.14] and proactively apply the changes to existing artifacts, as desired [304.15]. The controller is notified of the disposition of rules and will schedule the new evaluations as directed [304.2].

Likewise, the cognium used by machine automated curation may be changed by a human curator [305]. In a similar fashion to the human curated manual instructions previously described, the human curator will edit zero, one or more entries on a data store [305.10]. Artifacts may also optionally be included for reference [305.11]. The cognium concepts may be added, changed and deleted as desired [305.12 & 305.13]. Any changes may be saved backed to the cognium on a data store [305.14] and proactively applied to existing artifacts as needed [305.15]. If necessary, the controller is informed of the need for a new artifact evaluation and it is scheduled appropriately [305.2].

In some examples externally defined terms and concept sources are included in a cognium and manually defined terms and concepts are included [601]. When using an external source an instruction to register [601.1] the source is received. In this case the location and type of the source data is communicated to the registration process [601.10]. Its contents are read from a data store and appropriate cognits written into the cognium. Upon completion a notification is sent [601.2] indicating the success or failure and may include a summary of the process. Likewise an individual term and concept can be communicated directly [601.1] to the process. In this case the registration [601.10] does not read from a data store, it takes the information provided directly to the process and writes a cognit to the cognium. Upon completion [601.2] a similar notification is sent as previously described for [601.2].

In some examples cognits within a cognium are maintained by automated processes and in some examples by manual processes [602]. When automated processes are employed, the original term and concept source is read [602.10] and the related cognits read [602.11]. Comparisons are performed and the appropriate action determined [602.12]. This may result in the creation of additional cognits, updates to existing cognits, the creation of associations with other existing or newly created cognits and/or deletion of cognits. Upon completion a notification is sent [602.2] indicating the success or failure and may include a summary of the process. When manual processes are employed, the original term and concept may be provided manually or may be selected from an original source [602.10]. The appropriate cognit is read [602.11] and the maintenance action (add, update and delete) is selected manually [602.12]. Upon completion a notification is sent [602.2] indicating success or failure and may include a summary of the process.

In some examples cognits and one or more entire cognium or branches (subsets) of a cognium are annotated by processes to expand attributes, associations, values and/or relationships [603]. The cognium is read [603.10] as directed and annotations derived or directed are performed. Annotations may include but are not limited to specification of additional attributes on one or more cognits, elaborating cognit relationships and specification of processing rules for cognits and the cognium. All annotations are recorded in the cognium [603.11] and a notification is sent indicating success or failure and may include a summary of the process.

In some examples cognits are harmonized during and after registration, maintenance and annotation processes [604]. The cognium is read [604.11] and harmonized [604.12] using rules defined for the cognium and cognits. These are the same rules added during annotation processes [603] as well as integrity rules which may be applied to cogniums, such as cognit relationships cannot be self-contradicting or cause infinite loops (see the definition of cognium above). Upon completion a notification is sent [604.2] indicating success or failure and may include a summary of the process.

In many implementations the processes disclosed here are performed within the context of a larger IR system, which may include a controller. Where the specific methods disclosed here indicate a “Start” and/or “Stop” it may be inferred that this indicates where a controller initiates or receives notification of completion for a specific process. Thus, in any of these embodiments it can be inferred that a controller is involved, but is not required.

FIG. 700 illustrates a process wherein natural language input is utilized for the construction of a dimensionally articulated search in an IR system. The process is initiated by a controller or similar containing module [700.1] by the introduction of a natural language query input. [700.2]. The system responds by using NLP methods well known in the art to derive an abstraction pattern [1700.31] necessary to select cognits from a cognium. The ideal example generates a result set including but not limited to: a selection of root terms (morphemes); each root term with a selection of one or more putative ranked logical attribute associations; each root term with a selection of one or more putative dimensional associations; each root term with a selection of one or more putative vocabulary associations. These root terms and associations are, in many examples derived from comparisons to a known collection of such in a semantic reference data collection [1700.31]. When the root term selection data is complete the system proceeds to build collection of cognit-logical attribute pairs [700.4] based on comparisons with the root term selection data and one or more cogniums [1700.41]. The system then proceeds to assemble a presentation of the inferred dimensionally articulated query based on the original natural language input [700.5] and assembled from the selection of cognit-logical pairs. Note that the presentation of the inferred query may occur in a number of forms, including but not limited to: logical diagramming; audio presentation of the cognit-logical attribute pairs; implicit presentation via actual or putative result artifacts. The user may then tacitly or manually (depending on the precise implementation) accept or submit the query [700.6 to 700.61] thus ending the process [700.9], or alternatively may tacitly or implicitly reject the current inference [700.6 to 700.62] by either interacting with the dimensional articulation UI directly [700.7] or by modifying or entering a new natural language input [700.8].

FIG. 800 illustrates an embodiment for a process to provide dimensional hinting feedback. The process is initiated [800.1] with the input of a term [800.2]. The system responds by the selection of one or more variant terms that may represent the root term of that which was submitted [800.3]. This selection is made from one or more vocabularies [800.31]. The vocabularies from which root terms may be selected, in a preferred embodiment, is controlled by a tacit or manual selection by the user, but in alternate embodiments could be controlled by inferred factors from previous user interactions stored by the system. In some embodiments these inferred roots are displayed, and in other embodiments they are not. In some preferred embodiments there are two types of inferred terms: completion/correction terms and inferred roots. While the selection of these terms is intertwined, their usage later in the process is substantially different. Completion/correction terms are used to help the user complete or correct the formation of an incomplete or incorrectly formed term. For example, if the user provides input of “Michael J” the system may select the completion/correction term “Michael Jordan.” Alternatively, if the user provides input of “firtrukc” or “firetru” the system may select the completion/correction term “firetruck.” in some embodiments inferred roots are used to identify the correct cognit. Alternatively, in other embodiments, a cognium may be structured so that it contains root inference data. For example, if the user provides input of “the big apple” the system may select the inferred root “new york.” Alternatively, if the user provides input of “buses” the system may select the inferred root “bus.” In most embodiments it is desirable to rank or score the terms for applicability to an inference of the user's information need or intent. The system proceeds to present the completion/correction term to the user [800.4]. The user will either tacitly or manually select the completion/correction term [800.5] (or may otherwise alter their input). The selection of a particular completion/correction term, may in some embodiments return the process to the Select Term Inference Set step [800.3]. The system then proceeds to select one or more inferred dimensions [800.6] by comparisons of the term to those contained in the cognium [800.61]. For example, if the input term is “Michael Jordan” the system may select “person,” “basketball player” and “nba great.” The specific formulation and expression of dimensions will vary based on the embodiment of the cognium and the IR system; dimensional inferences may be multi-part: “person: professional athlete,” “person: nba great” and “person: african american.” These returned dimensional inferences are, in a preferred embodiment, scored or ranked by likelihood of being accurate to the users intent or information need. The system next presents the inferred dimension in the context of the appropriate object [800.7]. The user proceeds by tacitly or explicitly selecting an inferred dimension [800.8] (tacit selection are, in a preferred embodiment, the highest scored or ranked dimension). The selection concludes the dimensional hinting process [800.9].

FIG. 801 illustrates a process related to the generation of a set of dimensional hints, that in some embodiments this is equivalent to [800.6]. The process is initialized [801.1] by the input of a term [801.2]. The system then proceeds to select all relevant cognits [801.3] available in the cognium [801.24]. In some embodiments this occurs via a selection all valid stems for the given term by locating semantically variant pointer records (which may or may not be configured as cognits) [801.31] the selection of the distinct stem or root cognit records [801.22] and a possible repetition of the analysis for one or more vocabularies. The system next orders the cognits on the basis of a number of methods including but not limited to, an analysis algorithm or cognit values or algorithms that calculate the relative score of dimensions on the basis of other terms in the query [801.4]. The system proceeds by returning the ordered cognit set to the containing module or controller [801.5] and terminates [801.6].

FIG. 803 illustrates an integration of multiple vocabularies with dimensional hinting processes. The process begins [803.1] with the system having an initial vocabulary selection [803.2] being alternatively configured with one or more standard vocabularies or with the user having actively or tacitly selected one or more vocabularies. The process proceeds when the user inputs a term [803.3] and the system reacts by selecting one or more dimensional inferences (in the form of cognits) [803.4] that belong to the selected vocabularies by accessing stored Vocabulary and Semantic Data [803.41] in concert with a Cognium [803.42] (In some embodiments the semantic and vocabulary data may be included within the cognium, obviating a need for external vocabulary data sources). In most embodiments it is desirable to rank or score the resulting cognits for applicability to an inference of the user's information need or intent. In some embodiments comparisons may also be run against un-selected vocabularies to provide additional possible cognit selections [803.5]; to be used generally, or in the event that there are no matching cognits from the selected vocabularies; in most such alternate embodiments, cognits selected solely in association with the un-selected vocabularies [803.51] are modified to be ranked lower in their applicability to the user's information need or intent. In some embodiments alternated cogniums may also be employed to generate additional alternative selections [803.52]. Once all relevant cognits have been selected they are returned to the containing module or controller [803.6] terminating the process.

FIG. 804 illustrates a process for the generation of, and interaction with, pivot-focused dimensional hinting. The process is initialized [804.1] by the input one or more terms [804.2] comprising a query. Within the context of this disclosure “pivot” is a term that indicates modifying the dimensional association of a term and/or the addition of a new dimensionally associated term and/or the utilization of logical modifiers of a term within a query that provides a filtering effect eliminating unwanted artifacts from an IR system query. The process next selects and loads any stored business rules or other configured pivot data [804.31] and selects and loads any historical pivot data for the current and/or other users [804.32] and that are applicable to the current term [804.3]. This loaded data is in the form of alternate dimensional selections for current terms and/or new possible term-dimension additions to the current query. The process next performs pivot analysis [804.4] of all artifacts or a specified range of artifacts (a number of relevance ordered, top down selected records in most embodiments) to provide a selection of additional dimension selections and new dimension-term pairs, the inclusion into the query of which will eliminate potentially undesirable result artifacts. The process then presents a mix of the selected term-dimension, dimension and logical modifier pivots to the user [804.5]. Note that the precise mix and ordering of potential pivots will vary by embodiment, the precise method utilized being manifold and apparent to one skilled in the art. The process concludes with a tacit or explicit selection, or a tacit deferral of a selection [804.6] terminating the process [804.7].

FIG. 805 illustrates a process for the generation of pivot-focused dimensional hints. The process is initialized [805.1] by the input of one or more terms, comprising a query, along with any current pivot data [805.2]. The process next selects all or a business rule defined selection of artifacts and associated dimension scores currently returned by the query (the “current return”) [805.3]. The associated dimensions of current return undergo Mode Analysis [805.4] in order to determine a ranked selection of the most common dimensions across the current return [805.4]. The associated dimensions of the current return next undergo Cluster Analysis [805.5] in order to determine a ranked grouping of the root or other relational dimensions where returns are dimensionally clustered. This produces cluster dimension selections. The process then returns the most common selections and the cluster dimension selections to the containing module or controller as Pivot Recommendations [805.6], terminating the process [805.7].

FIG. 806 illustrates an apparatus for the presentation of pivot-focused hints from the context of a returned artifact. One example of a returned artifact is a SERP element—a reference to a single HTML page. The pictured embodiments are for screen display [806.1] and [806.2], though alternate embodiments may be for other presentation devices. Each embodiment has equivalent components: [806.11 and 806.21] both indicate a display of the general information that is appropriate for a given artifact, including but not limited to: a page (artifact) title; an excerpt; a contextual description; a hyperlink. Additionally, both embodiments indicate the presentation of one or more relevant dimensions or relevant dimension-term pairs (possible pivots) [806.12 through 806.1n] and [806.22 through 806.2n]. Both of these embodiments are in the context of an artifact presentation. The two alternate embodiments indicate variable positioning of various internal elements, but it will be obvious to anyone skilled in the art how these positions may be configured in a wide variety of ways. Depending on the embodiment various elements may also be hidden or displayed modally, based on associated HMI. In some embodiments the relative position, ordering, scaling or other sensory elements of each relevant dimension may be arranged and/or configured on the basis of scores of their relative likelihood of applicability to the user's information need or intent. In some of these embodiments the scores may be displayed or displayed via encoded sensory elements.

The inclusion or exclusion of a given relevant dimension or relevant dimension-term pair as a possible pivot is dependent on a number of factors, including but not limited to: pivot analysis designed to select dimensions and terms common with other artifacts in the current result set; pivot analysis designed to select dimensions and terms that reduce the overall size of the result set; pivot analysis designed to simplify the query by reducing the number of terms in the query; dimension/subdimension relationship analysis designed to select terms and dimensions that are clustered near common parent, child or otherwise networked cognits currently in the query or result set (for example, if a given query includes the term/dimension “subject:biology” suggested pivots may include “subject:anatomy” and “subject:primatology”).

FIG. 807 illustrates an apparatus for the presentation of pivot-focused hints from the context of a query. The pictured embodiment is for screen display [807.1], though alternate embodiments may be for other presentation devices. The embodiment indicates the presentation of a query UI [807.11] the presentation of a number of Pivot Hints [807.12 through 807.1n] and the presentation of an artifact result set (or portion thereof) [807.14]. This embodiment is in the context of query and results presentation. While a specific positioning is indicated of various internal elements, it will be obvious to anyone skilled in the art how these positions may be configured in a wide variety of ways. Depending on the embodiment various elements may also be hidden or displayed modally, based on associated HMI. In some embodiments the relative position, ordering, scaling or other sensory elements of each relevant dimension may be arranged and/or configured on the basis of scores of their relative likelihood of applicability to the user's information need or intent. In some of these embodiments the scores may be displayed or displayed via encoded sensory elements. The inclusion or exclusion of a given relevant dimension or relevant dimension-term pair as a possible pivot is dependent on a number of factors, including but not limited to: pivot analysis designed to select dimensions and terms common with other artifacts in the current result set; pivot analysis designed to select dimensions and terms that reduce the overall size of the result set; pivot analysis designed to simplify the query by reducing the number of terms in the query; dimension/subdimension relationship analysis designed to select terms and dimensions that are clustered near common parent, child or otherwise networked cognits currently in the query or result set (for example, if a given query includes the term/dimension “place:new york” suggested pivots may include “place:manhattan” and “activity:dining”); historic usage data in terms of other pivots selected in queries with similar terms or other pivots selected where the same artifacts were highly ranked.

In alternate embodiments, defining dimensional tag roots [1001] is performed manually through human activity, performed by automated processes and/or a collaboration of machine human processes. When human activities are included in the process, the dimensional tag root may be supplied [1001.1] or it may be derived from an existing root [1001.31]. The dimensional tag root is created and/or refined and registered in the cognium [1001.10]. Upon completion a response notification is sent to the initiating controller [1001.2]. When human activities are not included in the process, the dimensional tag root is supplied [1001.1], verified against the cognium to ensure uniqueness and validity and registered if appropriate [1001.10]. Upon completion a response notification is sent to the initiating controller [1001.2].

In some embodiments, tagging is performed by automated and/or manual processes [1002]. The suggested dimensional tag in all processes is provided for evaluation [1002.1]. The dimensional tag is verified against the cognium [1002.10] for use in associating an artifact with the dimensional tag. When evaluating for the purpose of performing the artifact curation, the common translation process [1003] is also employed. Upon completion a response notification is sent to the initiating controller [1002.2].

In some embodiments, translating is performed by automated processes [1003]. The suggested dimensional tag is provided by artifact curation processes and by IR query processes [1003.1]. The dimensional tag is reduced to its essential root as defined by the cognium [1003.10]. Critical to the translation via the cognium is the use of all the relationships defined between the cognits. For example, when a relationship is defined as hierarchical in the cognium, the translation of a term to its root can include the ancestral lineage defined by a relationship, consequently the root of “botany” can include “biology”. It is also possible the dimensional tag does not exist or cannot be reduced thus producing an empty result. In some alternate implementations (focused on query expansion, for example) such translations to roots could also be accomplished via non-hierarchical relationships or in the descendant rather than ancestor direction of the hierarchy. Upon completion a response notification is sent to the initiating process [1003.2].

In linguistic morphology and information retrieval, stemming is the process for reducing inflected (or sometimes derived) words to their stem, base or root form—generally a written word form. The stem need not be identical to the morphological root of the word; it is usually sufficient that related words map to the same stem, even if this stem is not in itself a valid root. Algorithms for stemming have been studied in computer science since at least 1968. Many search engines treat words with the same stem as synonyms as a kind of query broadening, a process called conflation. While the application of stemming algorithms and techniques are unique for an embodiment in their application to dimensional tags, the algorithms and techniques may include but are not limited to those available and well known to anyone skilled in the art. These may be use individually or mixed in any combination necessary as dictated by the needs of an embodiment. Some of the more common include:

Lookup: Find the inflected form of a term in a lookup table to determine the root term, for example, “notes” will appear in a table with the root “note”.

Suffix-stripping: Remove well known word endings to derive the root term, for example, “notes” will have the trailing “s” stripped away.

Lemmatization: Determines the part of speech for a word, e.g. plural, past tense, etc, and apply an appropriate normalization rule.

Stochastic: Apply probability scores in a computer learning algorithm to determine the root word.

Affix: The prefix and/or suffix is identified and stripped away to form the root.

Matching: Words are reduced to roots which may not exist as real words by matching the largest possible defined root, for example, “browsers”, “browser”, “browsing” and “browse” may all be reduced to “brows”.

As mentioned in an example in the Detailed Description above, an algorithmic stemming specific to the use of a cognium may include a Cognological Relationship stemming technique. This can be done via a hierarchical relationship within the cognium between various cognits such as “biology is a parent of botany” and/or as a defined stem root relationship defined between cognits in which one skilled in the art could apply a Lookup or other related technique using such a relationship.

In some embodiments, creating and maintaining a role based index is a machine process [1101]. A directive is sent to the process to manage the index content, this may include but is not limited to: create a new index; or update (refresh) an existing index [1101.1]. Appropriate artifact dimensional tags [1101.11] and associated artifacts [1101.10], as directed, are read from a data store. Possible roles defined for any index include but are not limited to: dimensional tag content relating to individuals (biographical); artifact content relating to retail transactions; and user custom dimension definitions. The necessary information is collected and compiled [1101.12] then saved to the directed index or indices [1101.13]. More than one replicated (identical) index may be needed by the IR system to ensure timely and prompt response time to all queries. Indexes may or may not be hosted in the same data store, same equipment rack or the same geographical region. Upon completion a response notification is sent to the initiating controller [1101.2].

In some embodiments, using a role based index is an automated machine process [1102]. The process is initiated by directives from the controller [1102.1] which include information necessary perform a specific search. The search will be parsed and distributed based on matching the requested search to the roles of the managed indices [1102.10]. Each appropriate index is interrogated and the results collected into a single response [1102.11]. Additionally the results may be reduced based on directives from the initiating controller, this may include but is not limited to, a maximum result set, removal of duplicates, exclusionary settings and other filters. Upon completion a response notification is sent to the initiating controller [1102.2].

In some embodiments, creating a training artifact set is a human controlled machine process [1401]. The user initiates the creation process via a user interface (UI) starting with a blank entry form or canvas [1401.1]. Specific artifacts are read and reviewed for content [1401.10]. The user selects the artifacts appropriate for inclusion in the training set [1401.11]. When manipulation of the artifact set is complete, the set is saved in a cognium [1401.12] and associated with a cognit. Upon completion a response notification is sent to the initiating controller [1401.2].

In some embodiments, creating a training artifact set is an automated machine process [1401]. The process is initiated by directives from the controller [1401.1] which includes information necessary to select the desired artifacts for inclusion in the training artifact set. Specific artifacts may be retrieved using information passed from the controller [1401.10]. The final selections are qualified as directed [1401.11]. When manipulation of the artifact set is complete, the set is saved in a cognium [1401.12] and associated with a cognit. Upon completion a response notification is sent to the initiating controller [1401.2].

In some embodiments, editing a training artifact set is a human controlled machine process [1402]. The user initiates the creation process via a user interface (UI) [1402.1]. An existing training artifact set is read from the cognium [1402.10]. The user selects additional artifacts appropriate for inclusion in the training set and/or removes those no longer needed [1402.11]. When manipulation of the artifact set is complete, the set is saved in a cognium either as a new set or replacing the original set [1402.12]. Upon completion a response notification is sent to the initiating controller [1402.2].

In some embodiments, editing a training artifact set is an automated machine process [1402]. The process is initiated by directives from the controller [1402.1] which includes information necessary to make the desired changes in the training artifact set. Specific artifacts may be added and others removed using information passed from the controller [1402.10]. The final selections are qualified as directed [1402.11]. When manipulation of the artifact set is complete, the set is saved in a cognium either as a new set or replacing the original set as directed [1402.12]. Upon completion a response notification is sent to the initiating controller [1402.2].

In some embodiments, using a training artifact set is an automated machine process [1403]. The process is initiated by directives from the controller [1403.1] which includes information necessary to select the desired training set, generate and save the resulting pattern analysis. The specified training set is read [1403.10]. The referenced artifacts are read [1403.11] and analyzed for patterns using machine learning processes which may be contained in various internal and external modules, depending on the precise embodiment [1403.12]. The resulting pattern analysis is saved in a cognium [1403.31] and associated with a cognit. Analysis may include statistical tracking for pattern applications to perform feedback and improvements to both automated and human controlled processes. Special rules may be implemented when pattern application statistics cross defined thresholds. These rules may include but are not limited to, excessive numbers of matching patterns, minimal numbers of matching patterns, contradicting patterns and so forth. Actions taken as a result of special rules may include but are not limited to editing of training sets and/or warning notifications to IR system administrators. Upon completion a response notification is sent to the initiating controller [1403.2].

The term of “sememetically linked” connotes a condition or state where a given term is associated with a single primary sememe. It may also refer to a state where one or more additional alternative secondary (or alternative) sememe have been associated with the same term. Each associated primary or secondary sememe association may be scored or ranked for applicability to the inferred user intent. Each associated primary or secondary sememe association may also be additionally scored or ranked by manual selection from the user.

The term “sememetic pivot” describes a set of steps wherein a user tacitly or manually selects one sememetic association as opposed to another and the specific down-process effects such a decision has on the resulting artifact selection or putative artifact selection an IR system may produce in response to selecting one association as opposed to the other.

FIG. 1700 illustrates an example of a process to provide sememetic hinting feedback and affordances for sememetic feedback interactions. The process is initiated [1700.1] with the input of a term [1700.2]. The system responds by generating a list of possible sememetic matches to the contextual intended meaning of the term [1700.3]. This list is generated by the selection of one or more cognits stored in a cognium [1700.31], where in each selected sememe represents a possible dimensional interpretation of the given term. Each possible sememetic presentation is scored or ranked based on its inferred relevance to the contextual intended meaning. The system next presents the sememetic inference to the user [1700.4] In an example embodiment this includes but does not require the presentation of, or the presentation of information about, artifact results or putative artifact results. The system presents the sememe with the highest rank or score as a tacit default. Depending on the precise implementation, a selection of the other possible inferred sememes may also be displayed as alternatives. The user will either tacitly or manually select a given sememe inference [1700.5], which will have the specific effect of altering the displayed or putative displayed result artifacts of the IR system. The user may then opt to perform a sememetic pivot [1700.6] by selecting a different sememe inference [1700.61] which will alter any current presentation of artifact results.

FIG. 1701 illustrates an example apparatus for the presentation of inferences and hints from the context of an IR system query. The pictured embodiment is for screen display [1701.1], though alternate embodiments may be for other presentation devices. This example includes the presentation of a query UI [1701.11], which includes one or more term objects [1701.111], which are in turn incorporate a number of components, including, but not limited to: a term (i.e. populated term input field) [1701.1111]; a selected sememetic inference [1701.1112]; the (in some examples optional or modal) display of a sememe definition [1701.1113], which may include one or more images, text components, drawings or other media or interactive objects used to communicate the definition of the selected sememe; one or more sememe pivot hints [1701.1114] which represent alternative inferences of the selected sememe, which, when manually selected by the user modify the term so that the given alternative inferences become the active selected inference [1701.1112]. This example also includes the presentation of one or more sememe pivot hints in an alternative location [1701.12 through 1701.1n] within the general presentation: one generally skilled in the art will understand that the precise location and context of these may be modified to provide various forms and modes of emphasis, communication and affordance. This example also includes a section for artifact presentation [1701.14] which may include, but is not limited to a page of results (SERP), meta information, summary information or other forms of representation of information about an actual or putative selected set of artifact results that may be refreshed or updated on the basis of selections or other interactions with other presented objects.

FIG. 1702 illustrates an example apparatus for the presentation of sememe information from the context of a returned artifact. One example of a returned artifact is a SERP element—a reference to a single HTML page. The pictured embodiments are for screen display [1702.1] and [1702.2], though alternate embodiments may be for other presentation devices. Each embodiment has equivalent components: [1702.11 and 1702.21] both indicate a presentation of the general information that is appropriate for a given artifact, including but not limited to: a page (artifact) title; an excerpt; a contextual description; a hyperlink. Additionally, both embodiments indicate the presentation of one or more relevant sememes (possible pivots via selection and via various HMI activities promotion to a term within a parent or descendant query) [1702.12 through 1702.1n] and [1702.22 through 1702.2n]. Both of these embodiments are in the context of an artifact presentation. The two alternate embodiments indicate variable positioning of various internal elements, but it will be obvious to anyone skilled in the art how these positions may be configured in a wide variety of ways. Depending on the embodiment various elements may also be hidden or displayed modally, based on associated HMI. In some embodiments the relative position, ordering, scaling or other sensory elements of each relevant dimension may be arranged and/or configured on the basis of scores of their relative likelihood of applicability to the user's information need or intent. In some of these embodiments the scores may be displayed or displayed via encoded sensory elements.

The inclusion or exclusion of a given relevant sememe as a possible pivot is dependent on a number of factors, including but not limited to: pivot analysis designed to select sememes in common with other artifacts in the current result set; pivot analysis designed to select sememes that reduce the overall size of the result set; pivot analysis designed to simplify the query by reducing the number of terms in the query; dimension/subdimension relationship analysis designed to select sememes that are clustered near common parent, child or otherwise networked cognits currently in the query or result set (for example, if a given query includes the sememe “subject:american history” suggested sememe pivots may include “event:american revolution” and “subject:capitalism”).

### Interpretation Considerations

When reading this section (which describes and details salient to the drawings and tables, hereinafter “drawing descriptions”), one should keep in mind several points.

The objects, features, and advantages of the examples described in the drawing descriptions will be apparent from the following more particular description of preferred or example embodiments as illustrated in the accompanying drawings, in which reference characters refer to the same parts throughout the various views. The drawings are not necessarily to scale, emphasis instead being placed upon illustrating principles of the disclosure.

### Graphical Symbols & Elements

Graphical symbols and elements in the drawings and drawing descriptions generally have the following meanings.

Octagons, i.e. rectangles with clipped corners, represent an interaction with the other system components and a system controller responsible for managing activity traffic.

Rectangles with rounded corners represent some processing or execution of logic within the system, a software module or software component, that may or may not require human interaction.

Rectangles without rounded corners represent an artifact or data record, or a subset of an artifact or data record.

Cylinders, i.e. rectangles overlaid with an oval at the top, represent a data store.

Lozenges (or diamonds), i.e. rhombus, represents one of one or more decision paths.

Unidirectional Lines, i.e. a line with no decoration or a square at one end point and an arrow at the other end point, and Bidirectional Lines, i.e. a line with an arrow at both end points, represent a logical flow of activities between two components of the process being illustrated; these activities include but are not limited to messages, data and transfer of control.

Lines without direction indicia, i.e. a line with no additional characteristics at either end, represent a general association between artifacts and/or data records.

All lines, regardless of end point decorations or characteristics, with one or more right angle bends and no spatial gaps is considered a single line with end points identified at the touch points to one of the graphical symbols or elements defined previously.

These figures are not formal logic flow charts and are not intended to represent the various conditional tests and repetitions that can and will occur in any example or embodiment of the invention, rather they are intended to illustrate the principles and logical components of an example.

1. A method, comprising:
collecting a set of artifact records, wherein boundaries of the set are determined by the correlation of one or more query items with one or more cognits;
selecting the set, wherein selecting the set is determined by the correlation of artifact records with one or more cognits; and
modifying the selection of the set being according to a correlation of artifact records with Boolean logic modifiers for one or more cognits.

2. The method of claim 1, further comprising utilizing cogniums in the context of an information retrieval system.

3. The method of claim 1, further comprising utilizing cogniums in the context of an information extraction system.

4. The method of claim 1, further comprising utilizing cogniums in the context of a data mining system.

5. The method of claim 1, further comprising utilizing cognits in the context of an information retrieval system.

6. The method of claim 1, further comprising utilizing a cognium data structure in the context of an information retrieval system.

7. The method of claim 1, further comprising utilizing a cognit data structure in the context of an information retrieval.
